(19) United States
(12) Patent Application Publication
(10) Pub. No.: US 2025/0281904 A1
(43) Pub. Date: Sep. 11, 2025

(54) SORBENT

(71) Applicant: Norwegian University of Science and Technology, Trondheim (NO)

(72) Inventors: De Chen, Trondheim (NO); Kumar Ranjan Rout, Trondheim (NO); Dumitrita Spinu, Trondheim (NO)

(21) Appl. No.: 18/998,511

(22) PCT Filed: Jul. 26, 2023
(86) PCT No.: PCT/EP2023/070710

§ 371 Date: Jan. 26, 2025

(30) Foreign Application Priority Data
Jul. 26, 2022 (GB) 2210902.9

(51) Int. Cl. B01J 20/32; B01D 53/62; B01D 53/81; B01D 53/96; B01J 20/22; B01J 20/28; B01J 20/34

(52) U.S. Cl. CPC B01J 20/3257; B01D 53/62; B01D 53/81; B01D 53/96; B01J 20/22; B01J 20/28016; B01J 20/28059; B01J 20/28071; B01J 20/28073; B01J 20/28083; B01J 20/3204; B01J 20/3219; B01J 20/3425; B01J 20/3483; B01D 2253/20; B01D 2253/306; B01D 2253/308; B01D 2253/311; B01D 2253/34; B01D 2257/504; B01D 2258/06; B01D 2259/40088

(57) ABSTRACT

Disclosed herein is a solid sorbent for use in a carbon dioxide capture process, the sorbent comprising a solid sorbent support that comprises pores; and secondary amines that are covalently attached to the solid sorbent support, wherein the secondary amines are confined inside the pores of the solid sorbent support and are present at a density that is greater than 4 amine groups/nm². Also disclosed herein is a method of preparing the solid sorbent of the invention, a method for the regeneration of the solid sorbent of the invention, the use of the solid sorbent in the adsorption of carbon dioxide, and the use of the solid sorbent in a carbon dioxide capture process that employs temperature swing adsorption with carbon dioxide purge as a desorption strategy.

### FIELD

The present disclosure relates to sorbents for use in a carbon dioxide capture process.

### BACKGROUND

There is a lot of environmental pressure to reduce the emissions of carbon dioxide gas into the atmosphere. A known technology for greatly reducing the carbon dioxide released into the atmosphere is carbon capture and storage, CCS. CCS comprises a sorbent capturing at least some, and preferably substantially all, of the carbon dioxide content of a gas mixture. When the gas mixture is eventually released into the atmosphere, its carbon dioxide content is reduced due to the carbon dioxide capture process. The sorbent may be generated by a process that releases the carbon dioxide in a contained environment. The regenerated sorbent may then be reused in the capturing process of carbon dioxide from a gas mixture. CCS is described in more detail below.

CCS has been explored as a viable method for reducing anthropogenic CO2 emissions, given that carbon-based fuels still remain the primary source of energy [Ref: 1]. Due to the possibility of cost-effective retrofitting in existing power plants, post-combustion CO2 capture technologies have been widely investigated in comparison to pre-combustion and oxy-combustion CO2 capture systems [Ref: 2]. Among existing CO2 separation methods, such as cryogenics, membrane, adsorption and absorption, the latter has received the most attention [Refs: 3,4]. It is based on aqueous alkanolamine solutions and has been the most studied and industrially implemented post-combustion CO2 sequestration approach in the last 50 years [Refs: 5,6]. Despite the long-term evaluation, the amine scrubbing process is still an expensive technology. The energy penalty associated with this process comes mainly from the energy required to heat-up the entire 30% amine (e.g., monoethanolamine (MEA)) in water solution and high energy for breaking the carbamate/carbonate species and release the CO2, where about 150-180 KJ/mol is typically required. A large part of total energy is dissipated on heating-up and vaporization of the water [Ref: 7]. Furthermore, this technique has several other issues, such as amine loss, equipment corrosion and secondary pollution (e.g., acids, ammonia) [Ref: 7], prompting a search for alternatives. Solid sorbents such as zeolites, carbons, metal organic frameworks (MOF), and amine-functionalized on mesoporous materials, have been studied extensively to prevent the difficulties outlined above. However, no solid sorbents are able to fit the requirement for CO2 capture, namely high CO2 adsorption capacity, fast kinetics, high CO2 selectivity, mild regeneration conditions, long-term thermo-chemical stability, moisture tolerance and low cost [Ref: 8]. Because of large CO2 capacity at very low CO2 concentrations (<5%) and high CO2 selectivity, amine-based sorbents are a good choice for natural gas post-combustion gas treatment [Ref: 8]. There are three ways for loading amine on supports: impregnation, grafting, and in-situ polymerization. The first class is based on amine-containing polymers like polyethyleneimine (PEI) [Refs: 9-11], pentaethylenehexamine (PEHA) [Refs: 12,13], and tetraethylenepentamine (TEPA) [Refs: 14-16]. Because of their high amine density, CO2 capacities greater than 2 mmol/g are easily attained. However, the polymers are physically deposited on supports, so leaching becomes an issue at high regeneration temperature. In addition, formation of urea in the presence of oxygen and high concentration of CO2 in regeneration at high temperatures cause the decay, reducing the sorbent's lifetime [Refs: 10,16]. An effective approach to prevent it is to immobilize the amine structures on support surface via chemical connections (i.e. via covalent attachment) which refers to the grafting [Refs: 17-20] and in-situ polymerization of tethered monomer [Refs: 21,22] amine classes. Nevertheless, both classes are based on several synthesis steps, thus becoming more complex and resulting in a higher overall cost [Ref: 23]. At this stage, assessing the number of synthesis steps of amine solid sorbent classes is relative, because a lot of effort has been devoted to polymers structure modification to improve the thermo-chemical stability and optimize the adsorption heat before impregnation [Refs: 24-27]. Typically, structural adjustments perform worse from a CO2 uptake perspective than their original form because of amine density reduction and tertiary amine fraction increase [Ref: 24], thus approaching the CO2 capacities offered by grafted-based sorbents [Ref: 18]. Belmabkhout et al. [Ref: 28] demonstrated a high CO2 selectivity of a TRI-PE-MCM-41 sorbent by study a CO2 adsorption in a mixture of CH4, N2, H2 and CFAir (N2:O2=80:20) at 25° C. up to 1 bar, showing that the adsorbed amount of other gases is insignificant. As the natural gas-based flue gas comes with a high water concentration (7-10%) [Ref: 29] it is essential to evaluate the moisture effect. Water is widely recognized for boosting CO2 uptake by forming bicarbonate in addition to carbamate. However, because of amine-H2O hydrogen bond, water adsorbs at low adsorption temperature [Ref: 30], subsequently consuming part of energy in the regeneration step. Grafted amine is another interesting class of solid sorbents. The grafted secondary amine has been showed to have excellent thermal-chemical stability. However, relatively low CO2 adsorption capacity is its drawback.

Concerning the regeneration strategy, most research in this domain has been almost totally concentrated on generating sorbents with the largest adsorption capacity, leaving the regeneration aspect behind. So far, the desorption stage has been carried out using (i) temperature swing adsorption (TSA) with an inert purge gas such as N2 or He (TSA/Inert), also H2O with a subsequent condensation (TSA/H2O), or CO2 (TSA/CO2), and (ii) pressure swing adsorption (PSA) mostly as a vacuum swing adsorption (VSA) alone or in combination with TSA [Refs: 8,31]. A substantial part of prior research used TSA/Inert to regenerate the sorbent [Refs: 9,12,13,16,17,21,32-35], which fundamentally relies on supplying enough energy aided by the concentration driving force to reverse the exothermic reaction. This helps in evaluating the sorbent's thermal stability, but it does not concentrate the CO2 for later compression and delivery to a storage point, implying that more research is needed to establish a viable separation process. Using TSA/H2O necessitates vaporization and condensation of the water for each cycle, resulting in increased heat consumption. For amine-based solvents, the CO2 stripping with steam was found to expel part of the amine, necessitating a concentration adjustment with fresh amine, resulting in an additional cost [Ref: 7]. As water affects the polymer viscosity, a similar concern may apply to low-molecular weight amine-based polymers physically deposited on solid supports. Unlike TSA/H2O, TSA/CO2 may directly produce a CO2 concentrated flow ready for storage by employing CO2 as a sweep gas. Thermodynamically this is feasible at temperatures above 120° C., depending on the amine-containing compound structure. However, the thermal stability of physically impregnated polymers would be significantly compromised under these conditions. Moreover, the amine groups would undergo an irreversible reaction with CO2 generating urea species as a result [Refs: 24,26,36]. Several studies used epoxy-compounds to partly convert the primary amines, which are more prone to deactivation, to stabilize the amine structures [Refs: 24,26]. Regardless of the achieved stability, the CO2 uptake at low CO2 partial pressure significantly decreased due to increase in molecular weight and tertiary amines.

When amine-containing polymers are to be employed, VSA is a gentle approach because it preserves the sorbet's CO2 capacity and thermo-chemical stability [Ref: 25] and does not require further CO2 concentration downstream. However, using only vacuum, the desorption time increases very much, thus most of the studies show the combination of VSA/TSA [Ref: 31]. According to Bollini et al. [Ref: 31] the cost of the vacuum equipment and the process itself might be too expensive. In addition, TSA/H2O and TSA/CO2 techniques become more appealing owing to the availability of waste heat in the power plants [Refs: 24,26].

There is a general need to improve sorbents for use in CCS systems.

### SUMMARY

The present invention provides a solid sorbent for use in a carbon dioxide capture process, the sorbent comprising:
a solid sorbent support that comprises pores; and
secondary amines that are covalently attached to the solid sorbent support, wherein the secondary amines are confined inside the pores of the solid sorbent support and are present at a density that is greater than 4 amine groups/nm².

The present invention also provides a method of preparing a solid sorbent for use in a carbon dioxide capture process, the sorbent comprising:
a solid sorbent support that comprises pores; and
secondary amines that are covalently attached to solid sorbent support and are confined inside the pores of the solid sorbent support; the method comprising:
the step of contacting a solid sorbent support that comprises pores with
(a) a compound, wherein the compound comprises a secondary amine group and a group capable of forming a covalent bond to the solid sorbent support; and
(b) water; and wherein
the compound is present in an amount of from 2 to 6 mL of compound per gram of solid sorbent support; and
the water is present in an amount of from 0.5 to 1.5 mL of water per gram of solid sorbent support.

The present invention also provides a solid sorbent for use in a carbon dioxide capture process, the sorbent comprising:
a solid sorbent support that comprises pores; and
secondary amines that are covalently attached to the solid sorbent support and are confined inside the pores of the solid sorbent support; wherein
the solid sorbent is obtainable according to the above method of the present invention.

The present invention also provides a method for the regeneration of a solid sorbent for use in a carbon dioxide capture process, wherein:
a solid sorbent containing carbon dioxide is heated at a temperature of from 120 to 150° C., preferably at a temperature of from 130 to 145° C. to release the contained carbon dioxide; and
the solid sorbent is a solid sorbent according to the present invention.

The present invention also provides the use of a solid sorbent in the adsorption of carbon dioxide, wherein:
the absorption of carbon dioxide is performed at a temperature of less than 100° C.; and
the solid sorbent is a solid sorbent according to the present invention.

The present invention also provides the use of a solid sorbent in a carbon dioxide capture process that employs temperature swing adsorption with carbon dioxide purge as a desorption strategy, wherein the solid sorbent is a solid sorbent according to the present invention.

For the avoidance of doubt, all references to “a secondary amine” or “secondary amines” herein are equally contemplated as relating to a multiplicity of types of secondary amine where appropriate (i.e. one or more secondary amines that are covalently attached . . . wherein the one or more secondary amines are confined inside the pore of the solid sorbent support and are present at a density that is greater than 4 amine groups/nm²).

Optional aspects of the present invention are set out in the dependent claims and in the detailed description section below.

### LIST OF FIGURES

FIGS. 1a to 1d show nitrogen adsorption-desorption isotherms and the pore size distribution of PE-MCM-41, AS-(1-5)-0.6 and AS-3-(0.6-1.2); FIG. 1. legend: “N₂ physisorption of PE-MCM-41 and AS-X-Y series. (a and c) N₂ adsorption-desorption isotherms measured at −196° C. (comment: specific surface area calculated using Brunauer-Emmett-Teller (BET) model within the relative pressure range of 0.05-0.3 (b and d) Pore size distribution determined using Barrett-Joyner-Halenda (BJH) equation.”;

FIG. 2a shows the ratio of the decreased sorbent's pore volume (BJH method) and aminosilane's grafted volume (sorbent calcination in TGA), and nitrogen content of AS-X-0.6 series as a function of N-MAPTMS' volume to PE-MCM-41′weight ratio;

FIG. 2b shows the ratio of the decreased sorbent's pore volume (BJH method) and aminosilane's grafted volume (sorbent calcination in TGA), and nitrogen content of AS-3-Y series as a function of H₂O′volume to PE-MCM-41′weight ratio;

FIG. 2. legend: “The ratio of the decreased sorbent's pore volume (BJH method) and aminosilane's grafted volume (sorbent calcination in TGA), and nitrogen content of (a) AS-X-0.6 series as a function of N-MAPTMS′volume to PE-MCM-41′weight ratio and (b) AS-3-Y series as a function of H₂O′volume to PE-MCM-41′weight ratio.”;

FIG. 3 shows X-ray diffractograms of PE-MCM-41 and AS-3-Y series;

FIG. 4a shows the adsorption efficiency and capacity of (a) AS-X-0.6 series as a function of N-MAPTMS′volume to PE-MCM-41′weight ratio;

FIG. 4b shows AS-3-Y series as a function of H₂O′volume to PE-MCM-41′weight ratio;

FIG. 4c shows efficiency dependence on the amine groups density;

FIG. 4. legend: “The adsorption efficiency and capacity of (a) AS-X-0.6 series as a function of N-MAPTMS′volume to PE-MCM-41′weight ratio, and (b) AS-3-Y series as a function of H₂O′volume to PE-MCM-41′weight ratio; (c) Efficiency′ dependence on the amine groups density; (-) for adsorption capacity (legend AS-3-Y-C), ( . . . ) for adsorption efficiency (legend: AS-3-Y-E). Adsorption conditions: 40° C., 5% CO₂, flowrate: 100 mL/min, 101 kPa, 60 min. Each adsorption capacity point is an average of at least three measurements per sample.”

FIG. 5a shows CO₂ adsorption of AS-3-0.9 adsorbent with CO₂ adsorption profiles at 40, 50 and 60° C. in 5% CO₂ balance N₂, 101 kPa and 100 mL/min;

FIG. 5b shows CO₂ adsorption of AS-3-0.9 adsorbent with CO2 adsorption isotherms at 40, 50 and 60° C. within a CO₂ pressure range of 0.02-80 kPa balance N₂, 101 kPa, 100 mL/min;

FIG. 5c shows CO₂ adsorption of AS-3-0.9 adsorbent with CO₂ adsorption profiles at 40° C. within a CO₂ pressure range of 0.03-80 kPa balance N₂, 101 kPa, 100 mL/min;

FIG. 5. legend: “CO₂ adsorption of AS-3-0.9 adsorbent (a) CO₂ adsorption profiles at 40, 50 and 60° C. in 5% CO₂ balance N₂, 101 kPa and 100 mL/min (b) CO₂ adsorption isotherms at 40, 50 and 60° C. within a CO₂ pressure range of 0.02-80 kPa balance N₂, 101 kPa, 100 mL/min. Comment: each point was collected for 1 h (c) CO₂ adsorption profiles at 40° C. within a CO₂ pressure range of 0.03-80 kPa balance N₂, 101 kPa, 100 mL/min.”

FIG. 6 shows the long-term stability of AS-3-0.9 adsorbent over 205 TSA cycles; FIG. 6. legend: “Long-term stability of AS-3-0.9 adsorbent over 205 TSA cycles. Adsorption: 50° C., 80% CO₂ balance N2. Desorption: 145° C., 80% CO₂ balance N2. Cooling down to adsorption temperature: N2. Total run time: 423 h.”

FIG. 7 shows the long-term stability of AS-3-0.9 adsorbent over 99 TSA cycles; FIG. 7. legend: “Long-term stability of AS-3-0.9 adsorbent over 99 TSA cycles. Adsorption: 50° C., 5% CO₂, 10.5% O₂, 3% H₂O balance N₂ and Ar. Dry desorption: Ar. Wet desorption: 140° C., 77% CO₂, 4% H₂O balance Ar. Cooling down to adsorption temperature: Ar. Total run time: 366 h.”

FIG. 8a shows isosteric heats of adsorption of AS-3-0.9 sample as a function of adsorption temperature;

FIG. 8b shows fitting of adsorption heat-1/T experimental data and adsorption heat values determined by the extrapolation for temperature values of 393, 407 and 413 K;

FIG. 9 comprises Table 1 that shows structural properties of PE-MCM-41 and AS-X-Y adsorbents; and

FIG. 10 comprises Table 2 that shows a summary of dry 5% CO2 balance N2 adsorption capacity and efficiency data.

FIG. 11 comprises Table 3 that provides a comparison of a sorbent of the invention with prior sorbents. The title of Table 3 is “Comparison of sorbents”.

FIG. 12 shows a plot of efficiency vs amine group density for the sorbents of Table 3.

FIG. 13 provides an example determination of molecular weight added to the support per secondary amine unit (Mg) and molecular weight lost in calcination per secondary amine unit (Mc).

### DESCRIPTION

Embodiments of the invention provide an improved sorbent for use in CCS systems.

Embodiments provide high surface amine density solid sorbents for CO2 capture with a low energy regeneration.

Properties of CO2 capture adsorbent sorbents according to embodiments may include a high CO2 adsorption capacity, long-term-chemical stability at the adsorption and desorption conditions, fast kinetics, low regeneration heat, mild desorption conditions, high CO2 selectivity and low cost (material-preparation). Embodiments may provide sorbents with some, or all, of these attributes.

In particular, embodiments provide sorbents with:
Relatively high CO2 adsorption capacity ≈2 mmol/g_{sorbent}
High long-term thermo-chemical stability at adsorption-desorption conditions
Fast kinetics
Low heat amount for desorption system
High CO2 selectivity

Particularly advantageous properties of the CO2 capture adsorbent sorbents according to embodiments are (a) stability in the presence of oxygen (for instance in flue gas); (b) stability in the presence of pure CO2 (even at high temperatures); and (c) a regeneration heat that decreases with increasing temperature, achieving a zero regeneration heat at 120 to 140° C.

The sorbents according to embodiments include solid sorbents with grafted secondary amines. The sorbents may have an increased CO2 capacity than known sorbents. This may lower the energy penalty and cost of a CO2 capture process.

Thus, as described above, a first sorbent of the invention is a solid sorbent for use in a carbon dioxide capture process, the sorbent comprising:
a solid sorbent support that comprises pores; and
secondary amines that are covalently attached to the solid sorbent support, wherein the secondary amines are confined inside the pores of the solid sorbent support and are present at a density that is greater than 4 amine groups/nm².

Preferably, the solid sorbent support is silica, fused silica, silica gel, carbon, zeolites, alumina. Further preferably, the solid sorbent support is a silica sorbent support, such as mesoporous silica such as MCM-41 and SBA-15. More preferably, the silica sorbent support is MCM-41.

Further preferably, the silica sorbent support is a pore expanded mesoporous silica sorbent support. A particularly preferred pore expanded mesoporous silica sorbent support is pore expanded MCM-41 (PE-MCM-41).

Preferably, the secondary amines that are covalently attached to the solid sorbent support have structures containing one amine group, wherein the structures are preferably C₂-C₁₂ (preferably C₂-C₈) saturated hydrocarbyl structures containing one amino group. Further preferably, the secondary amines that are covalently attached to the solid sorbent support have structures according to formula (I):

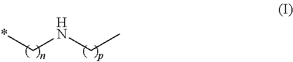 [SMILES: *CNCC]

wherein:
* denotes the point of attachment to an atom (preferably Si) that is covalently attached to, or forms part of, the solid sorbent support,
n is from 1 to 6, and
p is from 0 to 5.

Preferably, in the structure according to formula (I), n is from 2 to 5. Further preferably, n is from 2 to 4. Particularly preferably, n is 3.

Preferably, in the structure according to formula (I), p is from 0 to 4. Further preferably, p is from 0 to 3. Particularly preferably, p is 0 or 3. Most preferably, p is 0.

Preferably, in the structure according to formula (I), n is from 2 to 5 and p is from 0 to 3. Further preferably, n is from 2 to 4 and p is from 0 to 3. Further preferably still, n is 3 and p is from 0 to 3. Particularly preferably, n is 3 and p is 0 or 3. Most preferably, n is 3 and p is 0.

Particularly preferably, the secondary amines that are covalently attached to the solid sorbent support have structures according to formula (I′):

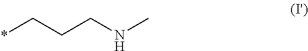 [SMILES: *CCCNC]

wherein:
* denotes the point of attachment to an atom (preferably Si) that is covalently attached to, or forms part of, the solid sorbent support.

In the structure according to formula (I), or in the structure according to formula (I′), an atom that is covalently attached to the solid sorbent support may be directly covalently attached to the solid sorbent or may be indirectly covalently attached to solid sorbent. The indirect covalent attachment may be via a polymer, such a polysiloxane polymer, where the atom forms part of the backbone (main chain) of the polymer.

Preferably, the secondary amines that are covalently attached to the solid sorbent support are derived from aminosilane compounds.

Preferably, the secondary amines are present at a density that is less than 6 amine groups/nm², preferably less than 5.8 amine groups/nm², further preferably less than 5.7 amine groups/nm², even further preferably less than 5.6 amine groups/nm², further preferably still less than 5.5 amine groups/nm², even further preferably still less than 5.4 amine groups/nm², most preferably less than 5.3 amine groups/nm².

Preferably, the secondary amine is present on the surface of the solid support at a density that is more than 4.4 amine groups/nm², preferably more than 4.5 amine groups/nm², further preferably more than 4.8 amine groups/nm², even further preferably more than 4.9 amine groups/nm², further preferably still more than 5.0 amine groups/nm², even further preferably still more than 5.1 amine groups/nm², most preferably more than 5.2 amine groups/nm².

Thus, in one embodiment, the secondary amine is present on the surface of the solid support at a density that is more than 4 amine groups/nm² and less than 6 amine groups/nm². Suitably, the secondary amine is present on the surface of the solid support at a density that is more than 5 amine groups/nm² and less than 6 amine groups/nm². Preferably, the secondary amine is present on the surface of the solid support at a density that is more than 4.4 amine groups/nm² and less than 6 amine groups/nm², preferably more than 4.4 amine groups/nm² and less than 5.8 amine groups/nm², further preferably more than 4.5 amine groups/nm² and less than 5.8 amine groups/nm², even further preferably more than 4.9 amine groups/nm² and less than 5.7 amine groups/nm², further preferably still more than 5.0 amine groups/nm² and less than 5.7 amine groups/nm², even further preferably still more than 5.1 amine groups/nm² and less than 5.7 amine groups/nm², most preferably more than 5.2 amine groups/nm² and less than 5.3 amine groups/nm².

Herein, the solid support includes the external surface of the solid support (i.e. the surface of the solid support that is not within the pores) and the surface of the solid support within the pores. Herein, the secondary amines that are covalently attached to the solid sorbent support are selectively covalently attached to the surface of the solid support within the pores, i.e. the secondary amines are confined inside the pores of the solid sorbent support.

Thus, in an embodiment, the secondary amines are covalently attached substantially exclusively to the surface of the solid sorbent support within the pores. In a particularly preferred embodiment, the secondary amines are covalently attached exclusively to the surface of the solid sorbent support within the pores, i.e. secondary amines are not attached to the external surface of the solid sorbent support.

Herein, “selectively covalently attached to the surface of the solid support within the pores” may mean that the solid sorbent of the invention has a ΔV/V_{amino-grafted} ratio of from 0.5 to 1.1, preferably of from 0.7 to 1.1, further preferably of from 0.8 to 1.1, even further preferably of from 0.85 to 1.15, further preferably still of from 0.85 to 1.05, even further preferably still of from 0.9 to 1.05, most preferably of from 0.98 to 1.02. Thus, the secondary amines may be confined inside the pores of the solid sorbent such the solid sorbent of the invention has a ΔV/V_{amino-grafted} ratio of from 0.5 to 1.1, preferably of from 0.7 to 1.1, further preferably of from 0.8 to 1.1, even further preferably of from 0.85 to 1.1, further preferably still of from 0.85 to 1.05, even further preferably still of from 0.9 to 1.05, most preferably of from 0.95 to 1.02. Ideally, the ΔV/V_{amino-grafted} ratio will be 1.

Thus, in an embodiment, the present invention provides a solid sorbent for use in a carbon dioxide capture process, the sorbent comprising:
a solid silica sorbent support that comprises pores; and
secondary amines that are covalently attached to the solid sorbent support, wherein the secondary amines that are covalently attached to the solid sorbent support have structures according to formula (I):

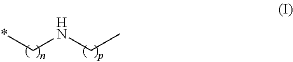 [SMILES: *CNCC]

wherein:
* denotes the point of attachment to an atom (preferably Si) that is covalently attached to, or forms part of, the solid sorbent support,
n is from 1 to 6, and
p is from 0 to 5; and
the secondary amines are confined inside the pores of the solid sorbent support and are present at a density that is more than 5 amine groups/nm² and less than 6 amine groups/nm².

In another embodiment, the present invention provides a solid sorbent for use in a carbon dioxide capture process, the sorbent comprising:
a solid silica sorbent support that is pore expanded MCM-41; and
secondary amines that are covalently attached to the solid sorbent support, wherein the secondary amines that are covalently attached to the solid sorbent support have a structure according to formula (I′):

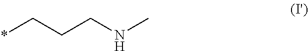 [SMILES: *CCCNC]

wherein:
* denotes the point of attachment to an atom (preferably Si) that is covalently attached to, or forms part of, the solid sorbent support; and
the secondary amines are confined inside the pores of the solid sorbent support and are present at a density that is more than 5 amine groups/nm² and less than 6 amine groups/nm².

Embodiments provide a method to prepare such solid sorbents by controlling the grafting location, using e.g. N-methylaminopropyltrimethoxysilane grafting and polymerization along the high surface area of e.g. pore expanded MCM-41. The preparation parameters are optimized by tuning the aminosilane/SiO2 and H2O/SiO2 ratios to achieve a high density of amine groups (e.g. 5.25 amine groups/nm²), and selective location inside to pores, thus leading to a very good adsorption efficiency (such as 0.52 mol CO2/mol N) and the superior capacity.

Thus, as described above, a method of the invention is a method of preparing a solid sorbent for use in a carbon dioxide capture process, the sorbent comprising:
a solid sorbent support that comprises pores; and
secondary amines that are covalently attached to the solid sorbent support and are confined inside the pores of the solid sorbent support; the method comprising:
the step of contacting a solid sorbent support that comprises pores with
(a) a compound, wherein the compound comprises a secondary amine group and a group capable of forming a covalent bond to the solid sorbent support; and
(b) water; and wherein
the compound is present in an amount of from 2 to 6 mL of compound per gram of solid sorbent support; and
the water is present in an amount of from 0.5 to 1.5 mL of water per gram of solid sorbent support.

Preferably, the solid sorbent support is silica, fused silica, silica gel, carbon, zeolites, alumina. Further preferably, the solid sorbent support is a silica sorbent support, such as mesoporous silica such as MCM-41 and SAB-15. More preferably, the silica sorbent support is MCM-41.

Further preferably, the silica sorbent support is a pore expanded mesoporous silica sorbent support. A particularly preferred pore expanded mesoporous silica sorbent support is pore expanded MCM-41 (PE-MCM-41).

Preferably, the pore expanded MCM-41 is obtainable by a method comprising:
(a) contacting a surfactant (such as hexadecyltrimethylammonium bromide, CTAB) with a silica networking forming agent (such as tetraethyl orthosilicate, TEOS) in the presence of water and a mineralizing agent (such as ammonia),
(b) collecting resulting product, and
(c) calcining the resulting product.

Preferably, the solid sorbent support for contacting has surface area of from around 700 to around 1100 m²/g, further preferably from around 750 to around 1050 m²/g, further preferably still from around 800 to around 1000 m²/g, even further preferably still of around 850 to around 950 m²/g, most preferably of from around 890 to around 910 m²/g.

Preferably, the solid sorbent support for contacting has a pore volume of from around 1.2 to around 2.0 cm³/g, further preferably from around 1.3 to around 1.9 cm³/g, further preferably still from around 1.4 to around 1.8 cm³/g, even further preferably still of around 1.5 to around 1.7 cm³/g, most preferably of from around 1.6 to around 1.7 cm³/g.

Preferably, the solid sorbent support for contacting has a mean pore diameter of from around 5 to around 10 nm, further preferably from around 6 to around 9 nm, further preferably still from around 6.5 to around 8.5 nm, even further preferably still of around 7 to around 8 nm, most preferably of from around 7.3 to around 7.7 nm.

Preferably, therefore, the solid sorbent support for contacting has:
(a) a surface area of from around 700 to around 1100 m²/g, and/or
(b) a pore volume of from around 1.2 to around 2.0 cm³/g, and/or
(c) a mean pore diameter of from around 5 to around 10 nm.

Further preferably, the solid sorbent support for contacting has:
(a) a surface area of from around 850 to around 950 m²/g, and/or
(b) a pore volume of from around 1.5 to around 1.7 cm³/g, and/or
(c) a mean pore diameter of from around 7 to around 8 nm.

Most preferably, the solid sorbent support for contacting has:
(a) a surface area of from around 890 to around 910 m²/g, and/or
(b) a pore volume of from around 1.6 to around 1.7 cm³/g, and/or
(c) a mean pore diameter of from around 7.3 to around 7.7 nm.

Preferably, the compound contains one amine group.

Preferably, the compound is an aminosilane. Further preferably, the aminosilane contains one amine group. Even further preferably, the aminosilane contains a C₂-C₁₂ (preferably C₂-C₈) saturated hydrocarbyl structure containing one amino group. Particularly preferably, the aminosilane is a compound of formula (II)

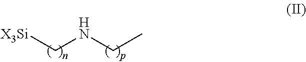

wherein:
each X is independently a leaving group,
n is from 1 to 6, and
p is from 0 to 5.

Preferably, each X is independently a leaving group selected from the group consisting of a halo group or a C₁-C₁₀ alkoxy group. Preferably, each X is independently a C₁-C₆ alkoxy group. Particularly preferably, each X is independently —OCH₃ or —OCH₂CH₃.

Most preferably each X is —OCH₃.

Preferably, in the structure according to formula (II), n is from 2 to 5. Further preferably, n is from 2 to 4. Particularly preferably, n is 3.

Preferably, in the structure according to formula (II), p is from 0 to 4. Further preferably, p is from 0 to 3. Particularly preferably, p is 0 or 3. Most preferably, p is 0.

Preferably, in the structure according to formula (II), n is from 2 to 5 and p is from 0 to 4. Further preferably, n is from 2 to 4 and p is from 0 to 3. Further preferably still, n is 3 and p is from 0 to 3. Particularly preferably, n is 3 and p is 0 or 3. Most preferably, n is 3 and p is 0.

Preferably, in the structure according to formula (II):
each X is independently a C₁-C₆ alkoxy group;
n is from 2 to 5; and
p is from 0 to 4.

Further preferably, in the structure according to formula (II):
each X is independently —OCH₃ or —OCH₂CH₃
n is from 2 to 4; and
p is from 0 to 3.

Thus, in one embodiment the aminosilane is N-methylaminopropyltrimethoxysilane or N-butylaminopropyltrimethoxysilane. Most preferably, the aminosilane is N-methylaminopropyltrimethoxysilane.

Preferably, the water is distilled water.

Preferably, the contacting step is carried out in the presence of toluene, optionally at reflux. Preferably, the toluene is present in an amount of from 140 to 417 mL of toluene per gram of solid sorbent support. More preferably, the toluene is present in an amount of from 140 to 300 mL of toluene per gram of solid sorbent support. Even more preferably, the toluene is present in an amount of from 140 to 200 mL of toluene per gram of solid sorbent support. More preferably still, the toluene is present in an amount of from 140 to 160 mL of toluene per gram of solid sorbent support. Most preferably, the toluene is present in an amount of around 140 to 300 mL of toluene per gram of solid sorbent support.

Preferably, in the contacting, the compound is present in an amount of from 2 to 5 mL of compound per gram of solid sorbent support. Further preferably, the compound is present in an amount of from 2.5 to 4.5 mL of compound per gram of solid sorbent support. Further preferably still, the compound is present in an amount of from 2.5 to 4 mL of compound per gram of solid sorbent support. Even further preferably still, the compound is present in an amount of from 2.5 to 3.5 mL of compound per gram of solid sorbent support. Most preferably, the compound is present in an amount of from 2.8 to 3.2 mL of compound per gram of solid sorbent support. Ideally, the compound is present in an amount of about 3 mL of compound per gram of solid sorbent support.

Preferably, in the contacting, the water is present in an amount of from 0.55 to 1.5 mL of water per gram of solid sorbent support. Further preferably, the water is present in an amount of from 0.6 to 1.5 mL of water per gram of solid sorbent support. Further preferably still, the water is present in an amount of from 0.7 to 1.3 mL of water per gram of solid sorbent support. Even further preferably still, the water is present in an amount of from 0.7 to 1.2 mL of water per gram of solid sorbent support. Even further preferably still, the water is present in an amount of from 0.8 to 1.2 mL of water per gram of solid sorbent support. Most preferably, the water is present in an amount of from 0.9 to 1.2 mL of water per gram of solid sorbent support. Ideally, the water is present in an amount of from 0.9 mL of water per gram of solid sorbent support.

Therefore, preferably, the compound is present in an amount of from 2 to 5 mL of compound per gram of solid sorbent support, and
the water is present in an amount of from 0.6 to 1.5 mL of water per gram of solid sorbent support.

Further preferably, the compound is present in an amount of from 2.5 to 4 mL of compound per gram of solid sorbent support, and
the water is present in an amount of from 0.7 to 1.2 mL of water per gram of solid sorbent support.

Further preferably still, the compound is present in an amount of from 2.5 to 3.5 mL of compound per gram of solid sorbent support, and
the water is present in an amount of from 0.8 to 1.2 mL of water per gram of solid sorbent support.

More preferably still, the compound is present in an amount of from 2.5 to 3.5 mL of compound per gram of solid sorbent support, and
the water is present in an amount of from 0.9 to 1.2 mL of water per gram of solid sorbent support.

Even more preferably, the compound is present in an amount of from 2.5 to 3.5 mL of compound per gram of solid sorbent support, and
the water is present in an amount of 0.9 mL of water per gram of solid sorbent support.

Preferably, the compound is present in an amount of 3 mL of compound per gram of solid sorbent support, and
the water is present in an amount of from 0.7 to 1.3 mL of water per gram of solid sorbent support.

Further preferably, the compound is present in an amount of 3 mL of compound per gram of solid sorbent support, and
the water is present in an amount of from 0.7 to 1.2 mL of water per gram of solid sorbent support.

Even further preferably still, the compound is present in an amount of 3 mL of compound per gram of solid sorbent support, and
the water is present in an amount of from 0.9 to 1.2 mL of water per gram of solid sorbent support.

Alternatively, preferably:
the compound is present in an amount of 2.0 to 2.4 mL of compound per gram of solid sorbent support, and
the water is present in an amount of from 0.6 to 0.9 mL of water per gram of solid sorbent support; or
the compound is present in an amount of 2.5 to 5 mL of compound per gram of solid sorbent support, and
the water is present in an amount of from 0.7 to 1.3 mL of water per gram of solid sorbent support.

More preferably:
the compound is present in an amount of 2.0 to 2.4 mL of compound per gram of solid sorbent support, and
the water is present in an amount of from 0.6 to 0.8 mL of water per gram of solid sorbent support; or
the compound is present in an amount of 2.5 to 4 mL of compound per gram of solid sorbent support, and
the water is present in an amount of from 0.7 to 1.3 mL of water per gram of solid sorbent support.

An embodiment provides a novel sorbent (AS-3-0.9) based on the supported secondary amine. The sorbent has been developed with high CO2 capacity (>2 mmol/g) and excellent stability in high temperature pure CO₂ regeneration. Thus, most preferably, the compound is present in an amount of 3 mL of compound per gram of solid sorbent support, and
the water is present in an amount of 0.9 of water per gram of solid sorbent support.

In the contacting step, a secondary amine is selectively covalently attached to the solid support within the pores, i.e. the secondary amine is confined inside the pores of the solid sorbent support. Preferably, therefore, the resulting solid sorbent has a ΔV/V_{amino-grafted} ratio of from 0.5 to 1.1, preferably of from 0.7 to 1.1, further preferably of from 0.8 to 1.1, even further preferably of from 0.85 to 1.1, further preferably still of from 0.85 to 1.05, even further preferably still of from 0.9 to 1.05, most preferably of from 0.95 to 1.02. Ideally, the ΔV/V_{amino-grafted} ratio will be 1.

In one embodiment, in the contacting step, the solid sorbent support that comprises pores is contacted with the compound and the water in a single step.

In another embodiment, in the contacting step, the solid sorbent support that comprises pores is contacted with the compound in a step-wise manner. For instance, the solid sorbent support that comprises pores is contacted with the compound by (a) addition of a first portion of the compound to the solid sorbent support, and (b) addition one or more further portions of the compound (for instance, one, two or three further portions) to the solid sorbent support. In one embodiment, each portion is of an equal volume. Preferably, an amount of time (for instance, at least 10 minutes, preferably at least 20 minutes, more preferably at least 30 minutes, most preferably at least one hour) is allowed to elapse before the addition of a further portion of the compound to the solid sorbent support.

In an embodiment, the present invention provides a method of preparing a solid sorbent for use in a carbon dioxide capture process, the sorbent comprising:
a solid sorbent support that comprises pores; and
secondary amines that are covalently attached to the solid sorbent support and are confined inside the pores of the solid sorbent support; the method comprising:
the step of contacting a solid silica sorbent support that comprises pores with (a) a compound, wherein the compound is a compound of formula (II)

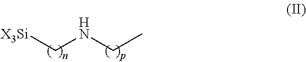

wherein:
each X is independently a C₁-C₆ alkoxy group,
n is from 2 to 5, and
p is from 0 to 4; and
(b) water; and wherein
the compound is present in an amount of from 2.5 to 4 mL of compound per gram of solid sorbent support, and
the water is present in an amount of from 0.7 to 1.2 mL of water per gram of solid sorbent support.

In another embodiment, the present invention provides a method of preparing a solid sorbent for use in a carbon dioxide capture process, the sorbent comprising: a solid sorbent support that comprises pores; and
secondary amines that are covalently attached to the solid sorbent support and are confined inside the pores of the solid sorbent support; the method comprising:
the step of contacting a solid silica sorbent support that is pore expanded MCM-41 with
(a) a compound, wherein the compound is N-methylaminopropyltrimethoxysilane; and
(b) water; and wherein
the compound is present in an amount of 2.0 to 2.4 mL of compound per gram of solid sorbent support, and
the water is present in an amount of from 0.6 to 0.9 mL of water per gram of solid sorbent support; or
the compound is present in an amount of 2.5 to 5 mL of compound per gram of solid sorbent support, and
the water is present in an amount of from 0.7 to 1.3 mL of water per gram of solid sorbent support.

In another preferred embodiment, the present invention provides a method of preparing a solid sorbent for use in a carbon dioxide capture process, the sorbent comprising:
a solid sorbent support that comprises pores; and
secondary amines that are covalently attached to the solid sorbent support and are confined inside the pores of the solid sorbent support; the method comprising:
the step of contacting a solid silica sorbent support that is pore expanded MCM-41 with (a) a compound, wherein the compound is N-methylaminopropyltrimethoxysilane; and (b) water; and wherein
the compound is present in an amount of from 2.5 to 3.5 mL of compound per gram of solid sorbent support, and
the water is present in an amount of from 0.8 to 1.2 mL of water per gram of solid sorbent support.

As discussed above, the present invention also provides a second solid sorbent for use in a carbon dioxide capture process, the sorbent comprising:
a solid sorbent support that comprises pores; and
secondary amines that are covalently attached to the solid sorbent support and are confined inside the pores of the solid sorbent support; wherein
the solid sorbent is obtainable according to the above method of the present invention.

The second solid sorbent of the present invention may share the features and preferred features of the first solid sorbent as defined above.

In addition, preferably, each of the first and second solid sorbents of the invention has a surface area of from around 20 to around 80 m²/g, further preferably from around 25 to around 70 m²/g, further preferably still from around 25 to around 60 m²/g, even further preferably still of around 30 to around 50 m²/g, most preferably of from around 30 to around 40 m²/g.

Preferably, each of the first and second solid sorbents of the invention has a pore volume of from around 0.15 to around 0.6 cm³/g, further preferably from around 0.2 to around 0.6 cm³/g, further preferably still from around 0.2 to around 0.5 cm³/g, even further preferably still of from around 0.2 to around 0.35 cm³/g, most preferably of from around 0.2 to around 0.3 cm³/g.

Preferably, each of the first and second solid sorbents of the invention has a mean pore diameter of from around 26 to around 33 nm, further preferably from around 27 to around 32 nm, further preferably still of from around 28 to around 31 nm, even further preferably still of around 29 to around 31 nm, most preferably of from around 29 to around 30.5 nm.

Preferably, therefore, each of the first and second solid sorbents of the invention has:
(a) a surface area of from around 20 to around 80 m²/g, and/or
(b) a pore volume of from around 0.15 to around 0.6 cm³/g, and/or
(c) a mean pore diameter of from around 26 to around 33 nm.

Further preferably, each of the first and second solid sorbents of the invention has:
(a) a surface area of from around 30 to around 50 m²/g, and/or
(b) a pore volume of from around 0.2 to around 0.35 cm³/g, and/or
(c) a mean pore diameter of from around 29 to around 31 nm.

Most preferably, each of the first and second solid sorbents of the invention has:
(a) a surface area of from around 30 to around 40 m²/g, and/or
(b) a pore volume of from around 0.2 to around 0.3 cm³/g, and/or
(c) a mean pore diameter of from around 29 to around 30.5 nm.

The solid sorbent according to embodiments may be used in a fixed bed reactor, such as a rotating fixed bed reactor. The solid sorbent according to embodiments may alternatively be formed into pellets or powder and used in a fluidised bed reactor or a moving bed reactor. In one particular embodiment the solid sorbent according to embodiments may be formed into powder and pelletised.

Thus, each of the first and second solid sorbents of the invention may be a sorbent for use in a fixed sorbent bed or in a moving sorbent bed. Thus, in one embodiment each of the first and second solid sorbents of the invention may be a sorbent for use in a fixed sorbent bed. In another embodiment each of the first and second solid sorbents of the invention may be a sorbent for use in a moving sorbent bed.

In addition, each of the first and second solid sorbents of the invention may be a sorbent for use in a pellet form or in a powder form. Thus, in one embodiment each of the first and second solid sorbents of the invention may be a sorbent for use in a pellet form. In another embodiment each of the first and second solid sorbents of the invention may be a sorbent for use in a powder form. The invention therefore further provides a pellet comprising each of the first and second solid sorbents of the invention, and powder comprising each of the first and second solid sorbents of the invention.

Furthermore, the long-term stability of the sorbents has been investigated by performing TSA cycles under 80% CO2 (423 h) and flue gas-like mixture (366 h) within the temperature range of 50-145° C. Over this time, no CO2 uptake loss was recorded, indicating that this material preserved its thermo-chemical stability against leaching, oxidative degradation, and urea formation. This demonstrates the sorbent's high potential for usage in a CO2 capture process that employs TSA/CO2 as a desorption strategy. In addition, the sorbent's performance at various CO2 concentrations and temperature was assessed, revealing very good kinetics and CO2 capacities at very low PCO2. As a result, the sorbent can capture CO2 from ppm values (e.g., direct air capture) to flue gas concentrations in power plants, as well as handle the concentration gradients in the sorbent's bed. Furthermore, the regeneration of the sorbents is particularly advantageous as the regeneration heat is close to zero MJ/kg CO2 and only sensible heat is required. Accordingly, as described above, the present invention provides a method for the regeneration of a solid sorbent for use in a carbon dioxide capture process, wherein: a solid sorbent containing carbon dioxide is heated at a temperature of from 120 to 150° C. to release the carbon dioxide contained in the solid sorbent; and the solid sorbent is a solid sorbent according to the present invention.

Preferably, the solid sorbent containing carbon dioxide is heated at a temperature of from 130 to 145° C., more preferably at a temperature of around 130 to 140° C., most preferably at a temperature of around 134° C.

Preferably, the solid sorbent containing carbon dioxide is heated in an atmosphere containing carbon dioxide, preferably containing from 10 to 100 vol % carbon dioxide, more preferably in an atmosphere containing from 40 to 100 vol % carbon dioxide, more preferably still in an atmosphere containing from 60 to 100 vol % carbon dioxide, even more preferably still in an atmosphere containing from 70 to 100 vol % carbon dioxide, most preferably in at atmosphere containing around 100 vol % carbon dioxide.

Thus, in an embodiment, the present invention provides a method for the regeneration of a solid sorbent for use in a carbon dioxide capture process, wherein:
a solid sorbent containing carbon dioxide is heated at a temperature of from 130 to 145° C. in an atmosphere containing from 60 to 100 vol % carbon dioxide to release the carbon dioxide contained in the solid sorbent; and
the solid sorbent is a solid sorbent according to the present invention.

In another embodiment, the present invention provides a method for the regeneration of a solid sorbent for use in a carbon dioxide capture process, wherein:
a solid sorbent containing carbon dioxide is heated at a temperature of from 130 to 140° C. in an atmosphere containing from 70 to 100 vol % carbon dioxide to release the carbon dioxide contained in the solid sorbent; and
the solid sorbent is a solid sorbent according to the present invention.

Further, as described above, the present invention also provides the use a solid sorbent in the adsorption of carbon dioxide, wherein:
the absorption of carbon dioxide is performed at a temperature of less than 100° C.;
the solid sorbent is a solid sorbent according to the present invention.

Preferably, the absorption of carbon dioxide is performed at a temperature of from 0 to 100° C., further preferably at a temperature of from 20 to 80° C., further preferably still at a temperature of from 30 to 70° C., most preferably at a temperature of from 40 to 60° C.

In an embodiment, the carbon dioxide is absorbed from air. Thus, in an embodiment, the present invention provides the use of a solid sorbent in the adsorption of carbon dioxide by direct air capture, wherein the solid sorbent is a solid sorbent according to the present invention.

In another embodiment, the carbon dioxide is absorbed from flue gas.

Thus, in an embodiment, the present invention provides the use a solid sorbent in the adsorption of carbon dioxide from flue gas, wherein:
the absorption of carbon dioxide is performed at a temperature of from 20 to 80° C.;
the solid sorbent is a solid sorbent according to the present invention.

In another embodiment, the present invention provides the use a solid sorbent in the adsorption of carbon dioxide from flue gas, wherein:
the absorption of carbon dioxide is performed at a temperature of from 40 to 60° C.;
the solid sorbent is a solid sorbent according to the present invention.

In addition, as described above, the present invention also provides the use of a solid sorbent in a carbon dioxide capture process that employs temperature swing adsorption with carbon dioxide purge as a desorption strategy, wherein the solid sorbent is a solid sorbent according to the present invention.

Preferably, the carbon dioxide capture process comprises the absorption of carbon dioxide as defined above. Further preferably, the carbon dioxide purge comprises the method for the regeneration of a solid sorbent for use in a carbon dioxide capture process as defined above, wherein the solid sorbent containing carbon dioxide is heated in an atmosphere containing carbon dioxide.

Accordingly, in an embodiment, the present invention provides the use of a solid sorbent in a carbon dioxide capture process that employs temperature swing adsorption with carbon dioxide purge as a desorption strategy, wherein
(a) the solid sorbent is a solid sorbent according to the present invention;
(b) the carbon dioxide capture process comprises the adsorption of carbon dioxide, wherein the absorption of carbon dioxide is performed at a temperature of less than 100° C.; and
(c) the carbon dioxide purge comprises a method wherein the solid sorbent containing carbon dioxide is heated at a temperature of from 120 to 150° C. in an atmosphere containing carbon dioxide to release the carbon dioxide contained in the solid sorbent.

In a preferred embodiment, the present invention provides the use of a solid sorbent in a carbon dioxide capture process that employs temperature swing adsorption with carbon dioxide purge as a desorption strategy, wherein
(a) the solid sorbent is a solid sorbent according to the present invention;
(b) the carbon dioxide capture process comprises the adsorption of carbon dioxide from flue gas, wherein the absorption of carbon dioxide is performed at a temperature of from 40 to 60° C.; and
(c) the carbon dioxide purge comprises a method wherein the solid sorbent containing carbon dioxide is heated at a temperature of from 130 to 140° C. in an atmosphere containing from 70 to 100 vol % carbon dioxide, most preferably 100 vol % carbon dioxide, to release the carbon dioxide contained in the solid sorbent.

### Definition of Parameters

Herein, the density of the secondary amines (expressed in amine groups/nm²) is determined by the following equation:

$$\frac{amine groups}{nm 2} = \frac{\frac{Δ w}{{M}_{c}} \cdot NA}{( 1 - \frac{Δ w}{{M}_{c}} \cdot {M}_{g} ) \cdot SA \cdot {10}^{18}}$$

Where Δw is the weight loss (in g) per gram of sorbent in the calcination in air between 120-800° C. determined by thermogravimetric analysis.

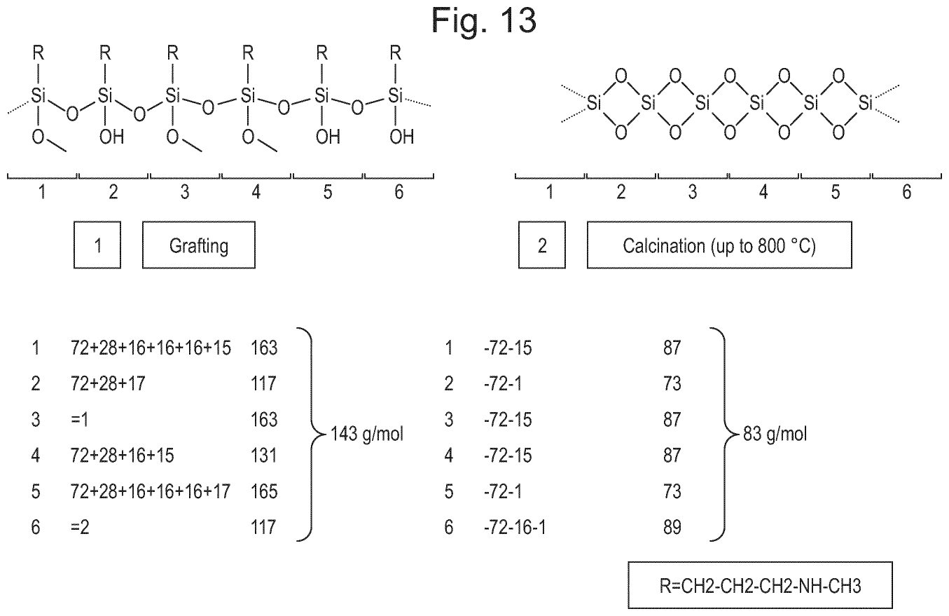

M_{c} is the molecular weight lost in calcination per secondary amine unit. When the secondary amines are derived from aminosilane compounds, the molecular weight lost in calcination per secondary amine unit is calculated as the average molecular weight lost per secondary amine unit for a notional aminosilane hexamer wherein the aminosilane hexamer has two oxygen atoms per silicon atoms and contains three silane units having a pendant alkoxy group and three silane units having a pendant hydroxyl group (see FIG. 13, structure 1). The molecular weight lost is assumed to be the sum of the molecular weight of the six amino groups, the three alkyl radicals (derived from the three alkoxy groups), two hydrogen atoms and one hydroxyl radical (derived from the three hydroxyl groups). The average molecular weight lost per secondary amine unit is therefore the molecular weight loss for the hexamer divided by six. When N-MAPTMS is used as the aminosilane, the molecular weight lost in calcination per secondary amine unit is 83 g/mol (see FIG. 13, conversion of structure 1 to structure 2).

For ease of calculation, it is noted that the concentration of N function group (mmol N/g_{sorbent}) is

$$\frac{Δ w}{{M}_{c}} \cdot 1000.$$

The above formula may therefore be conveniently re-arranged such that the concentration of N function group appears in the numerator.

NA is the Avogadro number (6.02214076·10²³).

The formula

$$( 1 - \frac{Δ w}{{M}_{c}} \cdot {M}_{g} ) \cdot SA \cdot {10}^{18}$$

provides the surface area of the support per gram of sorbent (nm² of the support in one gram of sorbent).

SA is the surface area of the support (i.e. expanded MCM-41) expressed in m²/g determined as defined below.

M_{g} is the molecular weight added to the support per secondary amine unit. When the secondary amines are derived from aminosilane compounds, the molecular weight added to the support per secondary amine unit is calculated as the average molecular weight added per secondary amine unit for a notional aminosilane hexamer wherein the aminosilane hexamer has two oxygen atoms per silicon atoms and contains three silane units having a pendant alkoxy group and three silane units having a pendant hydroxyl group (see FIG. 13, structure 1). The molecular weight added is assumed to be the sum of the molecular weights of the six silicon atoms, the twelve oxygen atoms, the six amino groups, the three alkyl radicals (derived from the three alkoxy groups), and the three hydrogen atoms (derived from the three hydroxyl groups). The average molecular weight added per secondary amine unit is therefore the molecular weight added by the hexamer divided by six. When N-MAPTMS is used as the aminosilane, the molecular weight added to the support per secondary amine unit is 143 g/mol (see FIG. 13, structure 1).

Example calculation for the density of the secondary amines of AS-3-0.9:

$$\begin{matrix}\frac{amine groups}{nm 2} = \frac{\frac{Δ w}{{M}_{c}} \cdot NA}{( 1 - \frac{Δ w}{{M}_{c}} \cdot {M}_{g} ) \cdot SA \cdot {10}^{18}} = \frac{\frac{0.3078}{83} \cdot 6.02214076 \cdot {10}^{23}}{( 1 - \frac{0.3078}{83} \cdot 143 ) \cdot 905 \cdot {10}^{18}} \\ = 5.22\end{matrix}$$

Herein, the value ΔV is determined by the following equation:

$$Δ V = {V}_{support} - {V}_{sorbent}$$

Vₛᵤₚₚₒᵣₜ is the pore volume of the support contained in 1 g of sorbent (expressed in cm³/g).

Vₛᵤₚₚₒᵣₜ=mₛ·PVₛᵤₚₚₒᵣₜ
PVₛᵤₚₚₒᵣₜ is the pore volume of the support per g of the support (expressed in cm³/g) as determined by the BJH method).
mₛ is the calculated mass (in g) of support contained in 1 gram of sorbent.

mₛ=1−m_{amino-grafted}
m_{amino-grafted} is the mass (in g) of each secondary amine unit (i.e. aminosilane derived unit) that is covalently attached to the solid sorbent support per gram of sorbent.

$${m}_{amino - grafted} = mol N / {g}_{sorbent} \cdot {M}_{g} = \frac{Δ w}{{M}_{c}} \cdot {M}_{g}$$

V_{sorbent} is the pore volume of the sorbent contained in 1 g of sorbent (expressed in cm³/g).

V_{sorbent}=PV_{sorbent}
PV_{sorbent} is the pore volume of the sorbent per g of the sorbent (expressed in cm³/g) as determined by the BJH method

Herein, the value of V_{amino-grafted} is determined according to the following equation:

$${V}_{amino - grafted} = \frac{{m}_{amino - grafted}}{{ρ}_{reagent}}$$

wherein ρ_{reagent} is the density (in g/cm³) of the compound that provides the secondary amines, i.e. that is used in forming the sorbent (i.e. the compound used in the method of the invention, preferably an aminosilane). When N-MAPTMS is used as the compound (i.e. the aminosilane), ρ_{reagent} is 0.978 g/cm³.

Example calculation for the ΔV/V_{amino-grafted} ratio of AS-3-0.9:

$${V}_{support} = ( 1 - \frac{0.31}{83} \cdot 143 ) \cdot 1.64 = 0.76 {cm}^{3} / g ;$$

$${V}_{sorbent} = {PV}_{sorbent} = 0.23 {cm}^{3} / g ;$$

$$Δ V = {V}_{support} - {V}_{sorbent} = 0.76 - 0.23 = 0.53 {cm}^{3} / g ;$$

$${V}_{aminosilane} = \frac{{m}_{g}}{{ρ}_{aminosilane}} = \frac{\frac{0.31}{83} \cdot 143}{0.978} = 0.55 {cm}^{3} / g ;$$

$$Δ V / {V}_{aminosilane} = 0 \text{.53} / 0.5584 = 0.96$$

Herein, surface areas (expressed in m²/g) are determined by N2-physisorption using the BET (Brunauer-Emmett-Teller) method.

Herein, pore volumes (expressed in cm³/g) are determined by N2-physisorption using the BJH (Barrett-Joyner-Halenda) method.

Herein, mean pore diameters (expressed in nm) are determined by N2-physisorption using the BJH (Barrett-Joyner-Halenda) method.

Results that demonstrate the performance of sorbents according to embodiments are set out below.

### Characterization of PE-MCM-41 and N-MAPTMS-Modified Materials

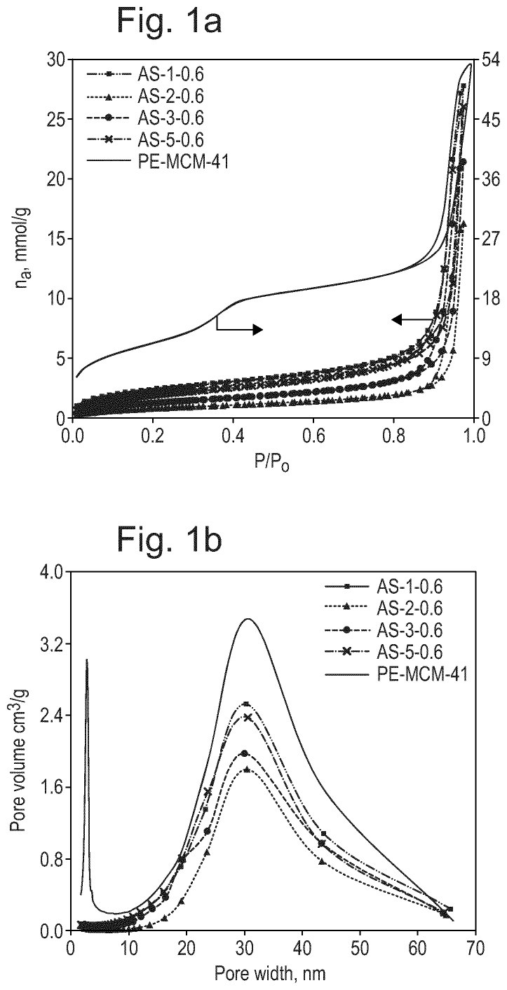

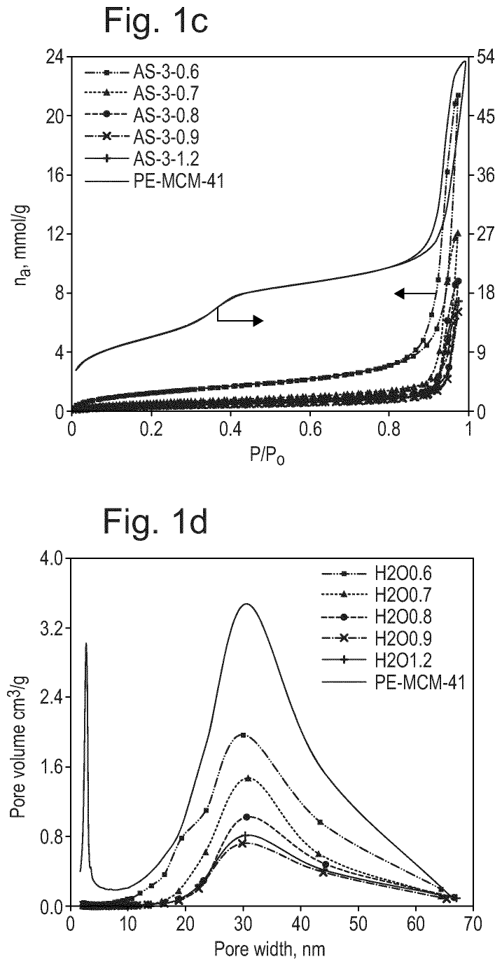

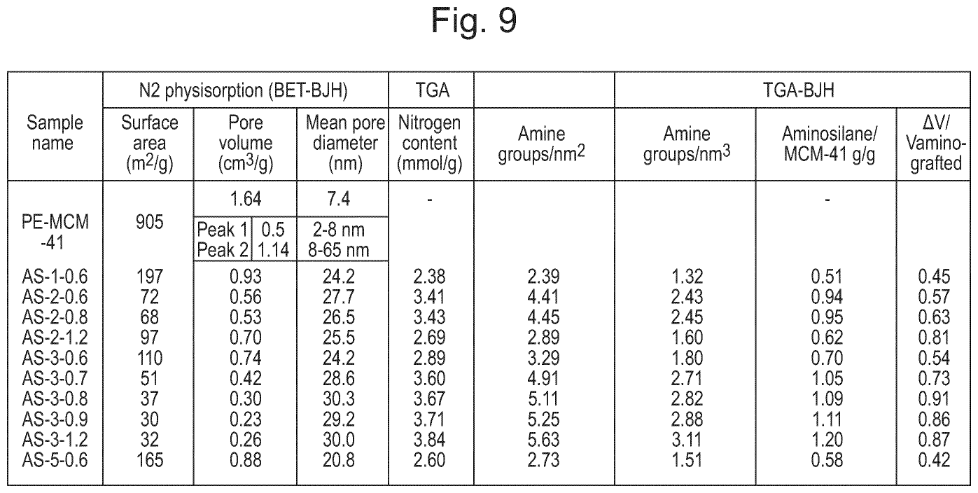

The structural properties of PE-MCM-41 and AS-X-Y obtained based on N2 physisorption technique are summarized in Table 1 as provided in FIG. 9. The nitrogen adsorption-desorption isotherms and the pore size distribution of PE-MCM-41, AS-(1-5)-0.6 and AS-3-(0.6-1.2) are shown in FIG. 1. Following the IUPAC classification, the N2 adsorption-desorption isotherms of PE-MCM-41 are of type IV with a hysteresis loop of type H1 (FIG. 1a). This indicates the presence of a narrow range of uniform mesopores in the silica material. Besides the recorded loop, there is also an adsorption-desorption step within the relative pressure range of 0.25-0.4 which also indicates the filling of mesopores, but in this case mesopores with an internal width within the lower limit range of the mesoporous domain (e.g, 2-50 nm according to IUPAC). FIG. 1b shows the bimodal pore size distribution of the PE-MCM-41 determined through the BJH method. The first peak is distributed over a narrow pore size range of 2-4 nm with a maximum at 2.5 nm and corresponds to the pore filling step noticed on the adsorption-desorption isotherms.

Meanwhile the second peak spreads over almost the entire mesoporous domain, even entering the lower limit of the macroporous range, and records the maximum at 30 nm.

The same analyses were performed for the N-MAPTMS-modified samples. The effects of aminosilane/SiO₂ and H₂O/SiO₂ ratios on the textural properties of the PE-MCM-41 structure are depicted in FIGS. 1a, b and 1c, d, respectively. Prior to grafting, PE-MCM-41 had a surface area of 905 m²/g, pore volume of 1.6 cm³/g, and a mean pore diameter of 7.4 nm. After grafting, when the aminosilne/SiO₂ was increased from 1 to 5 for the same H₂O/SiO₂ ratio of 0.6, the surface area and pore volume significantly decreased. However, the decrease is not continuous from 1 to 5, and it goes through a minimum at X=2. In case of the mean pore size, an increase is noticed up to X=2 and then it falls off (Table 1). The increase of the mean pore diameter with the grafting degree is a cause of filling of the small pores within the first and second peaks ranges. The first peak disappeared from the pore size distribution of the grafted samples and the second one shifted towards larger pore size (FIG. 1b). As shown in FIG. 1a, upon anchoring aminosilane to the surface of the SiO₂ pore structure, the N2 adsorption isotherms maintained type IV with hysteresis H1. In addition, the pore filling step at the relative pressure range of 0.25-0.4 vanished because of packing the small pores with aminosilane.

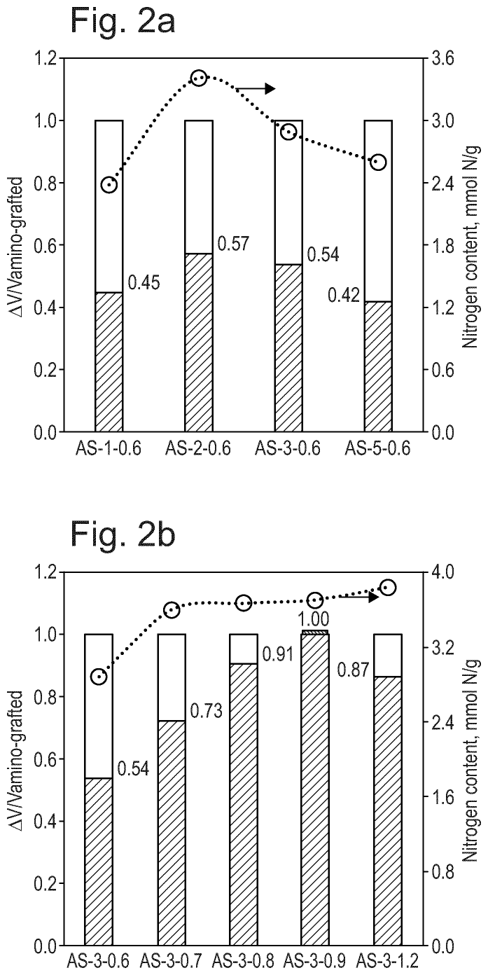

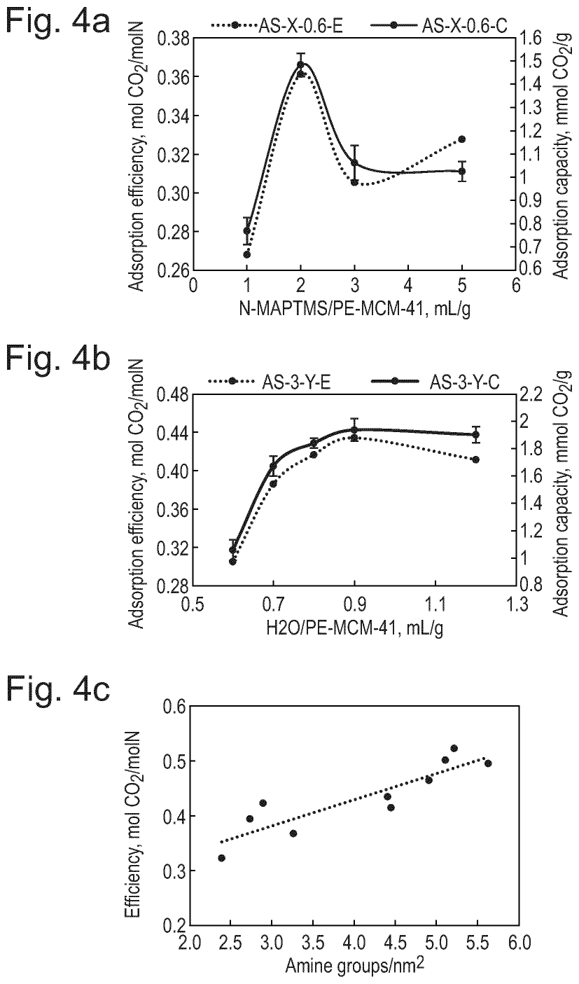

The addition of water has been clearly shown to enhance the grafting process through: (i) boosting the density of silanol groups on the silica surface, thus increasing the probability of alkoxy-hydroxyl groups contact, and (ii) promoting the formation of siloxane via hydrolysis and condensation of aminosilanes′alkoxy groups with the silanol groups from the silica surface and between themselves [Refs: 19, 35, 37]. Nevertheless, each aminoalkoxysilane responds specifically to the hydrolysis-condensation reactions because of nature of the amino-alkyl chain and alkoxy groups [Refs: 38 to 40]. Brochier Salon et al. [Ref: 38] studied the kinetics of hydrolysis and condensation reactions of various alkoxysilanes and the results showed that the presence of basic groups in the silane molecule intensifies the self-condensation reactivity resulting in 3D structure. Additionally, they also highlighted the inhibiting effect of steric-electronic hindrance of long chain and aromatic ring towards self-condensation. Altogether, this through study encourages to investigate carefully the selected alkoxysilane. According, herein the effect of H₂O on the grafting of AS-2-Y and AS-3-Y was examined. The samples were chosen based on their highest N content and best CO2 adsorption performance (FIGS. 2a, 4a). FIG. 1c, d shows the type IV of N₂ adsorption isotherms and unimodal pore size distributions of AS-3-Y samples. The surface area and pore volume notably decreased upon water content increase for AS-2-(0.6-0.8) and AS-3-(0.6-0.9) samples (Table 1). A further increase of water/silica ratio to 1.2 affected the grafting degree of both AS-2-1.2 and AS-3-1.2 samples, as an increase in surface area and pore volume was noticed.

Thermogravimetric analyses of the PE-MCM-41 and AS-X-Y products were performed to quantify the organic fragments of the grafted aminosilane. As described in the methods section, the weight loss recorded between 15° and 800° C. in oxygen atmosphere was considered for the calculation of nitrogen content (Table 1). The weight loss of PE-MCM-41 was measured to subtract it from the losses obtained for AS-X-Y samples. FIG. 2a depicts the change of nitrogen concentration and the ratio of the decreased pore volume (ΔV, BJH method) and the volume of grafted aminosilane (V_{amino-grafted}, TGA calcination) with N-MAPTMS/SiO₂ ratio. ΔV was calculated considering 1 g of support with subsequent filling with aminosilane (as described above), while the aminosilane volume was calculated based on the TGA calcination and the pristine aminosilane density (as described above). The ΔV/V_{amino-grafted} ratio value indicates an approximate location of aminosilane. For a ratio of 1, >1, and <1, the aminosilane is well-positioned inside the support pore volume via surface grafting, exhibits pore blockage, and is externally deposited to some extent, respectively. When the aminosilane/support ratio is increased to 2, a significant increase in ΔV/V_{amino-grafted} ratio and nitrogen content is noticed (FIG. 2a), followed by a reduction with further aminosilane addition. In factor, changes of aminosilane to SiO2 ratio various diffusion rate by varying the aminosilane concentration, and the hydrolysis and condensation rate by varying the aminosilane to water ratio. At relatively low aminosilane concentrations, enhancement of the diffusion with increase in aminosilane/support ratio is dominating, while at relatively high aminosilane concentrations, fast self-condense in the solution without being anchored to the support surface is dominating, reduced reactions inside pores. Harlick et al. [Ref: 18], Linneen et al. [Ref: 41] and Kim et al. [Ref: 42] also studied the effect of aminosilane (Tri-amine [Refs: 18, 41] and Di-amine [Ref: 42]) amount on the grafting efficiency, but in absence of water. Interestingly, Harlick et al. [Ref: 18] Linneen et al. [Ref: 41] reported a steady rise in nitrogen content as the aminosilane/silica ratio increased, with a sharp step in grafting effectiveness at 2 and 1 mL of aminosilane per g of SiO₂, respectively, and finally plateauing with additional aminosilane/SiO₂ ratio increase. In contrast, Kim et al. [Ref: 42]'s study found a constant N content within 0.67-1.11 g/g range of aminosilane/SiO₂ ratio, followed by a rapid decline when the ratio was increased to 2.22 g/g, which was assumed to be the result of uneven grafting throughout the porous media due to the pore opening blockage caused by a too high aminosilane concentration in the feed. Herein, the ΔV/V_{amino-grafted} ratio of all AS-X-0.6 are less than 1.

FIG. 2b shows the variation of ΔV/V_{amino-grafted} ratio and nitrogen content with H₂O/PE-MCM-41 ratio of AS-3-Y sorbents. It can be noticed the important role of water in hydrolysis and condensation of alkoxy groups. A rise in water concentration enhanced the hydration of silica surface which facilitated the bonding of aminosilane′alkoxy groups, followed then by the aminosilane self-condensation, progressively filling the pore volume.

The AS-3-0.9 sorbent attained a ΔV/V_{amino-grafted} ratio of 1.01, indicating the ideal case where all of the aminosilane polymer is confined inside the support pore volume. Linneen et al. [Ref: 41] and Harlick et al. [Ref: 19] studied the effect of water addition to a tri-amine functionalized silica. Interestingly, both works reported a maximum of amine loading at water/SiO₂ ratio of 0.3 mL/g. A further increase in water content did not raise the N content beyond this point, resulting in a plateau. A similar behaviour was observed by the inventors of embodiments for the AS-3-Y case. When the H₂O/PE-MCM-41 ratio reached 0.7, the N content rose until it reached 3.6 mmol N/g, where it subsequently plateaued. The observed decrease of ΔV/V_{amino-grafted} ratio and slightly increase in N content with further increase of water/PE-MCM-41 ratio to 1.2 could be attributed to the relatively high water/aminosilane ratio used for AS-3-1.2. A rapid hydrolysis-condensation of aminosilane outside the porous media may occur at too high water/aminosilane ratio, resulting in loss of active material [Ref: 38]. This may be corroborated by the fact that when performing the grafting process in toluene, sticky agglomerates developed over time and accumulated on the flask wall at high water/aminosilane ratios (e.g., the case of AS-2-1.2, AS-1-0.6).

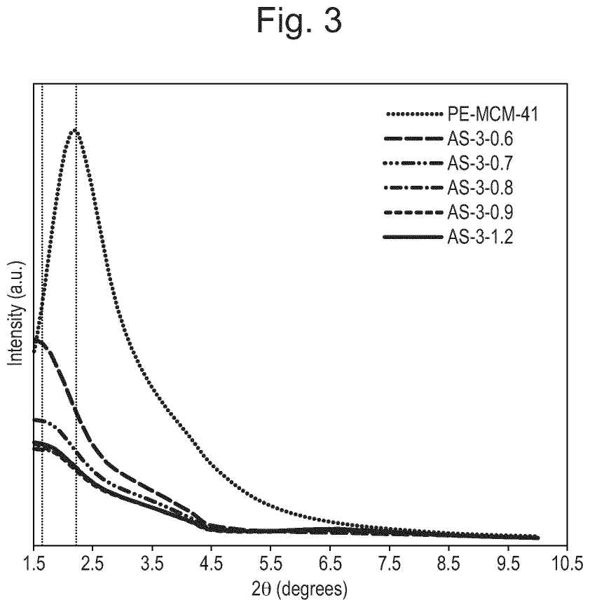

FIG. 3 depicts the XRD spectra of PE-MCM-41 and AS-3-Y samples. Only (100) reflection was detected at 2θ=2.3°, and a fading peak shoulder which might correspond to (110) and (200) reflections at 2θ=3.5-4.5°, indicating a short-range order of hexagonal structure of PE-MCM-41 [Ref: 43]. The intensity of (100) reflection substantially altered upon anchoring and polymerizing of more aminosilane in the porous silica structure. This indicates that d-spacing (d(100)) decreased continuously as pore occupancy with amine functional groups gradually increased [Ref: 44]. The (100) reflection intensity fell progressively as the water/silica ratio rose from 0.6 to 0.8, then remained nearly constant between 0.8 and 1.2. The plateau in reflection intensity found between 0.8 and 1.2 corresponds with the nitrogen content plateau (FIG. 2b), indicating effective grafting-polymerization of aminosilane inside the porous media of PE-MCM-41. Apart from a drop in (100) reflection intensity as the water/silica ratio of AS-3-Y samples increased, a gradual change to lower 20 from 2.3° to 1.65° was also seen, indicating a shift to larger cell characteristics. At the first glance, it appears to contradict the literature because the peak must migrate to greater angles when the cell parameters are reduced [Refs: 43, 45 to 47]. However, given the bimodal structure of PE-MCM-41, the mean pore size changes to greater values by filing first the small diameter pores (Table 1). This explains the progressive shift of (100) reflection to lower 20.

### CO₂ Sorption

FIG. 4a illustrates the impact of N-MAPTMS addition on CO₂ adsorption efficiency and capacity at 5 vol % CO₂ and 40° C. for 60 min. The AS-2-0.6 achieved the highest CO₂ loading and efficiency of 1.48 mmol/g and 0.43, respectively, followed by AS-3-0.6 (1.06 mmol/g and 0.37), AS-5-0.6 (1.02 mmol/g and 0.39) and AS-1-0.6 (0.77 mmol/g and 0.32). These trends variations are in line with those observed for N content and ΔV/V_{amino-grafted} ratio (FIG. 2a), indicating a relatively good dispersion of aminosilane and easily accessible amine sites. It is widely accepted in the literature that two amine sites (primary and/or secondary) are required to adsorb one CO₂ molecule in water-free conditions, which is a reaction involving carbamate production via deprotonation of zwitterion intermediate by a base (herein base-amine) [Refs: 17, 21, 47 to 51]. Given this, approximately 70% of AS-(2-5)-0.6 samples' amine sites engaged in carbamate formation, which is a rather high percentage considering that adsorption might be hampered by a variety of factors. One of these is the amine density which has been shown to be important in obtaining a high adsorption efficiency [Refs: 49 and 51]. Hori et al. [Ref: 49] grafted a primary aminosilane (APTMS) on MCM-41 and SBA-15, and interestingly, for the same aminosilane loading, a small pore size structures like MCM-41 (2.9 nm) reached a higher CO₂ adsorption capacity compared to SBA-15 (6.2 nm) and SBA-15 (10.6 nm). It was suggested that in small pores the carbamate formation is more effective because the amine sites can form carbamate not only with sidelong nearby amines, if considering polymerization in layers, but also with those positioned on the opposite half of the pore.

This may be available also for the bimodal pore structure of PE-MCM-41 according to embodiments, as too large pores (20-60 nm) may not be as effective as small ones. In addition, given the vast surface area and pore volume of the PE-MCM-41 support, a too low aminosilane/silica ratio, as in the case of AS-1-0.6 sample, may lead to a low density of aminosilane, thus reducing the effectiveness of carbamate formation even with a nearby amine. Moreover, the aminosilane employed in the study performed by the inventors of embodiments is more sterically constrained than a primary amine or primary-secondary diamine molecule due to its linked methyl group, making the carbamate formation more challenging. The carbamate complex's steric barrier is another factor, which may also impede CO₂ entry to the inner free amine sites, resulting in an efficiency lower than 0.5 [Refs: 52, 53]. Furthermore, water must be regarded as a major component in this study; according to Linneen et al. [Ref: 41], a water layer/pockets on the silica surface may stimulate a rapid polymerization of aminosilane, resulting in substantial barrier sites against CO₂ transport.

The effect of water/SiO₂ ratio on CO₂ adsorption performance of AS-3-Y samples is shown in FIG. 4b. The trends in CO₂ capacity accord with those observed for nitrogen content and ΔV/V_{amino-grafted} ratio (FIG. 2b). The maximum CO₂ capacity was reached by AS-3-0.9 with 1.94 mmol/g, followed by AS-3-1.2 with a nearly similar value of 1.90 mmol/g, before dropping to 1.84, 1.67 and 1.06 mmol/g for the AS-3-0.8, AS-3-0.7 and AS-3-0.6 samples, respectively. The CO₂ adsorption efficiency follows a similar behaviour, demonstrating that a highly dense amino-based framework developed along a high surface area and pore volume (ΔV/V_{amino-grafted}→1) is essential for driving the adsorption efficiency to a value close to theoretical one (0.5). The N surface density (amine groups/nm²) was calculated for all sorbents (Table 1, FIG. 4c) to show the CO2 adsorption efficiency dependence on the distance between adsorption sites. FIG. 4c indicates that an efficiency close to theoretical value can be easily obtained when the N surface density approaches 5 amine groups/nm². At this point, it is critical to examine the pore size of the support. Hori et al. [Ref: 49] has shown that for the same N surface density, the increase in the pore size lowered the CO2 adsorption capacity. This is because spreading the polymer across the entire cross-sectional area of the pore increases the likelihood of an amine group encountering another amine group in its immediate vicinity.

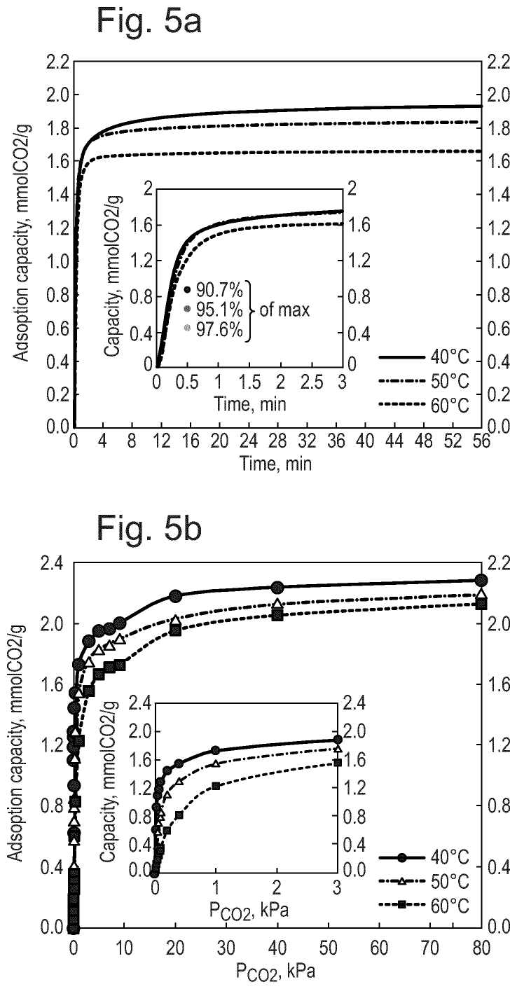

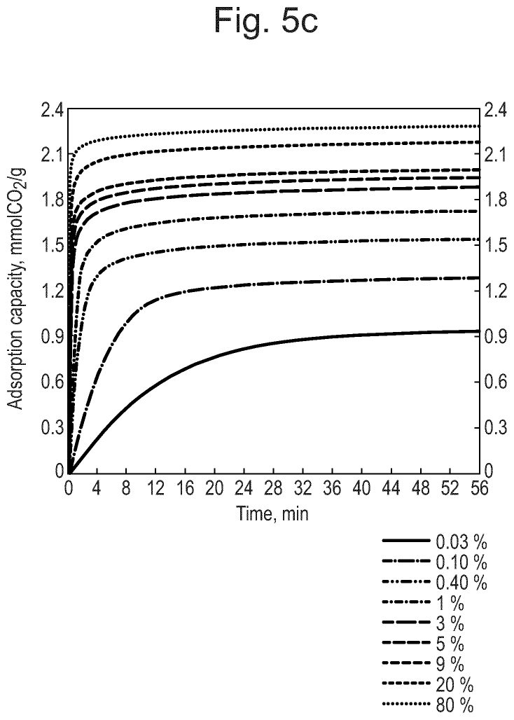

Aside from a high CO₂ adsorption capacity, the CO₂ adsorption kinetics is another essential metric to consider when evaluating an adsorbent's effectiveness. Due to its high CO₂ capacity, the AS-3-0.9 sample was chosen for kinetic study at 5% CO₂/N₂ at 40, 50 and 60° C. for 56 min. The uptake curves at different conditions are shown in FIG. 5a. Upon exposing the adsorbent to the gas mixture, an immediate increase in CO₂ uptake occurred, reaching 90.7, 95.1 and 97.6% of the maximum capacity (at 56 min) in only 3 min at 40, 50 and 60° C., respectively. This supports the idea that a combination of high surface area, pore volume and pore size may not only host and provide good dispersion of a large quantity of aminosilane, but also facilitate fast CO₂ diffusion towards amine sites, despite of MCM-41's less ordered and bimodal structure. In addition, because of the exothermic nature of the CO2-amine reaction [Refs: 18, 45, 47, 48], a reduction in temperature from 60 to 40° C. resulted in a CO2 capacity increase from 1.66 to 1.93. A similar trend was obtained for various grafting-based amine adsorbents or modified amine-based polymers like TEPA and PEI [Refs: 24, 25, 28, 41]. Linneen et al. [Ref: 41] performed dry grafting of Mono, Di and Tri-amino alkoxysilanes and obtained similar decreasing tendency of CO₂ uptake upon increasing temperature. The same was noticed even when wet grafting of Tri was carried out [Ref: 28]. However, in case of long amino-alkyl chain of TRI, a lower pore volume and surface area of the support, such as silica gel [Ref: 35], or/and high degree of polymerization of Tri [Ref: 41] may increase the inaccessibility of amine sites, resulting in a better performance at higher temperatures. This phenomenon is frequently seen at the adsorbents prepared via impregnation of amine-based polymers like PEI, TEPA, PEHA, into porous materials [Ref: 9, 25, 54 to 57]. High polymer loading and/or high molecular weight polymer impregnation, inhibit the mobility of amine sites and the migration of CO₂ through the viscous media. To increase the mobility, Yamada et al. [Ref: 25] converted the primary amines of TEPA to secondary by bonding various hydroxyl-alkyl and alkyl chains.

The results showed that the alkyl modified TEPA had an improved CO₂ diffusion compared to the pristine TEPA or hydroxyl-alkyl modified TEPA. The increased amine flexibility has been attributed to a diminution in hydrogen bonds that typically form between amines and amine-hydroxyl groups. A similar aspect may be applicable also for the aminosilane employed in this study, given that the amine has a methyl group linked to it, which prevents hydrogen bond formation with a neighbouring amine.

FIG. 5b depicts the CO₂ adsorption isotherm of AS-3-0.9 sample at 40, 50 and 60° C. within a CO₂ pressure range of 0.02-80 kPa (balance N₂/He, total flow: 100 mL/min, 101 kPa). In the CO₂ low-pressure range of 0.02-5 kPa, all isotherms show a sharp increase, indicating the CO₂-amine strong interaction [Refs: 17, 30, 58]. With a further rise in CO₂ partial pressure up to 80 kPa, the adsorbent's CO₂ capacity rose, albeit at a considerably lower slope. Serna-Guerrero et al. [Ref: 30] supports the fact that at a CO₂ partial pressure higher than 5%, CO₂ physisorption intervenes alongside chemisorption, leading in CO₂/N efficiencies greater than 0.5. Herein, at 40° C. and CO₂ partial pressure of 5, 40 and 80 kPa, the AS-3-0.9 recorded a CO₂ capacity of 1.95, 2.24 and 2.29 mmol/g, implying a CO₂/N efficiency of 0.44, 0.5 and 0.51, respectively. In this case it is difficult to define the chemisorbed and physisorbed CO₂ uptake fractions. It is possible that the adsorbent attained saturation of accessible amines at 5 kPa, and the subsequent CO₂ uptake at P_{CO2}>5 kPa was due to physisorption. Nevertheless, the CO₂/N efficiency achieved at 40° C. and 5 kPa is rather close to the theoretical value, suggesting both a very dense secondary monoamine framework and accessible amine sites in the AS-3-0.9 sample; these are two major factors for the efficient formation of carbamate. The adsorbent's CO₂ uptake continuously diminishes as the CO₂ partial pressure falls below 5 kPa. Because the CO₂ concentration in a post-combustion NGCC power plant ranges between 3-5 vol %, it is critical to maintain a high CO₂ capacity within this range and even at lower concentrations. It is also necessary to consider the concentration gradients across the adsorbent bed, which implies that the adsorbent must possess a high affinity for CO₂ molecules even in ultra-diluted gas mixtures containing 200-1000 ppm of CO₂. At 40° C. and P_{CO2} of 3, 1 and 0.03 kPa, AS-3-0.9 adsorbent achieved a capacity of 1.88, 1.73 and 0.94 mmol CO2/g, respectively. Belmabkhout et al. [Ref: 28] performed the CO2 adsorption isotherms of a TRI-PE-MCM-41 within the CO2 partial pressure range of 0.04-5 kPa. At 35° C. and P_{CO2} of 3, 1 and 0.04 kPa, a CO₂ capacity of 1.68, 1.4 and 0.98 mmol/g was obtained, respectively. Given that TRI-PE-MCM-41 had an amine loading of 7.9 mmol/g, the adsorbent developed in this study performed significantly better at low CO2 concentrations, while having substantially lower nitrogen content of 4.46 mmol/g when compared to TRI-PE-MCM-41. Anyanwu et al. [Ref: 35] obtained a CO₂ capacity of 1.098 mmol/g on a TRI-silica gel adsorbent at 25° C. and 415 ppm. A similar capacity was obtained with AS-3-0.9, but at 40° C.

FIG. 5c illustrates the CO₂ adsorption capacity vs time of AS-3-0.9 sample at 40° C. and CO₂ pressure range of 0.03-80 kPa. As the CO₂ partial pressure is reduced gradually from 5 to 0.03 kPa, the time required to attain the maximum capacity corresponding to each phase equilibrium rises. At 5, 3 and 1 kPa, the AS-3-0.9 adsorbent performed remarkably, reaching 90% of the maximum capacity in less than 2.6, 3.5 and 5 min, respectively. Even at low pressure as 0.1 kPa, the adsorbent achieved 90% of its equilibrium capacity in only 13 min. Only few studies explored the N-MAPTMS structure. Ko et al. [Ref: 47] and Zelenak et al. [Ref: 48] carried out dry grafting of N-MAPTMS on SBA-15 and SBA-12, and obtained a nitrogen content of 3.07 and 2.16 mmol/g, respectively. At 25° C., Ko et al. [Ref: 47]'s adsorbent gained 90% of maximum coverage corresponding to a P_{CO2} of 101 kPa (0.75 mmol CO2/g) after 25 min, while Zelenak et al. [Ref: 48]'s adsorbent did in roughly 5 min in 10% CO₂/N₂ (equilibrium CO2 capacity of 1.06). Given the low CO2 concentration used in the investigation by the inventors of embodiments, it can be inferred that AS-3-0.9 adsorbent outperformed the other adsorbents in terms of kinetics and total adsorption CO₂ capacity.

### Long-Term Cyclic Stability

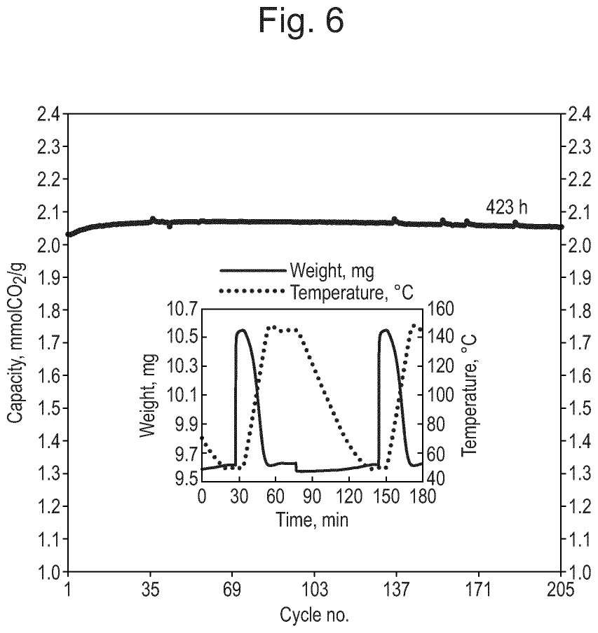

The long-term stability in CO2-rich flow of AS-3-0.9 adsorbent was evaluated in a series of 205 TSA cycles with adsorption and desorption temperatures of 50 and 145° C. in a gas mixture of 80% CO2/N2. FIG. 6 shows the stability results as well as the weight change and temperature profiles of two cycles. Over 204 cycles and time on stream of 423 h, the AS-3-0.9 adsorbent preserved its adsorption capacity, demonstrating its exceptional chemical and thermal stability. The weight change profile shows that a temperature of 145° C. thermodynamically favours a full desorption in 80% CO₂/N₂. Sayari et al. [Refs: 17, 36] meticulously studied the stability of various amine structures, including the N-MAPTMS.

Their results showed the outstanding stability of N-MAPTMS in a CO₂ rich atmosphere, with no sign of deactivation up to 200° C. IR-NMR investigations have already shown that when different amine structures are exposed to CO₂-rich gas mixtures and elevated temperatures, they produce stable urea species, which is a key cause in sorbent deactivation. Sayari et al. [Ref: 36]'s DRIFT and MAS NMR study has shown that primary amines, primary-secondary and secondary-secondary amines combinations (e.g., aminoalkoxysilanes (Di, Tri), polymers (L-PEI, B-PEI) undergo a rapid deactivation in dry CO₂ atmosphere and temperatures as high as 130-150° C. and form open-chain and cyclic urea species. [Ref: 10], Li et al. [Ref: 59] investigations show a detailed analysis of linear and branched PEI structures. According to their DRIFT results, a branched PEI with a molecular weight of 600 Da, started to develop a noticeable urea peak at 75° C. and grew very fast when rising the temperature to 121° C. Sayari et al. [Res: 17, 60]'s pMONO and Tri adsorbents, under pure CO₂, lost 21% over 60 cycles and 14% over 40 cycles at 55 and 50° C., respectively. There have been proposed two routes for amine deactivation to urea species [Ref: 17, 36]. The first one is based on the generation of isocyanate by dehydration of carbamic acid, leading to the formation of urea via a subsequent interaction with a neighbouring amine, whereas the second involves the formation of urea via dehydration of ammonium carbamate. Because of two available hydrogen atoms, isocyanate can only be produced from primary amines, while the nature of subsequent nearby amine to form urea is unimportant. These mechanisms were further validated by testing the adsorbents' stability in a humid CO2 atmosphere, and the presence of water has been proven to impede carbamic acid/ammonium carbamate from dehydration to some extent even at temperatures as high as 105-130° C. [Refs: 10, 59, 60]. Nevertheless, a TSA process with desorption based on pure CO₂ and elevated temperatures requires a stable sorbent in dry CO₂ environment. A desorption accompanied by CO₂ and water may not be the best approach, as water participates to the formation of bicarbonate, resulting in a shift of CO₂/N stoichiometry from 0.5 to 1 [Ref: 30, 61]. Moreover, when employing water, the Huang et al. [Ref: 61] and Serna-Guerrero et al. [Ref: 30]'s TPD data have shown a shift of the desorption peak's maximum toward higher temperatures, implying a stronger binding in the bicarbonate over carbamate. Although a CO₂/N stoichiometry of 1 is advantageous in the adsorption stage, it comes at a cost in the desorption step since higher temperatures may be required to achieve a reasonable working capacity. To verify this aspect, TPD analyses were performed on AS-3-0.9 sample in dry and wet conditions at 40 and 50° C. in 1% CO₂ with/w/o 2.3 or 3% H₂O, followed by a temperature ramp of 5° C./min to 120° C. to release the adsorbed CO₂.

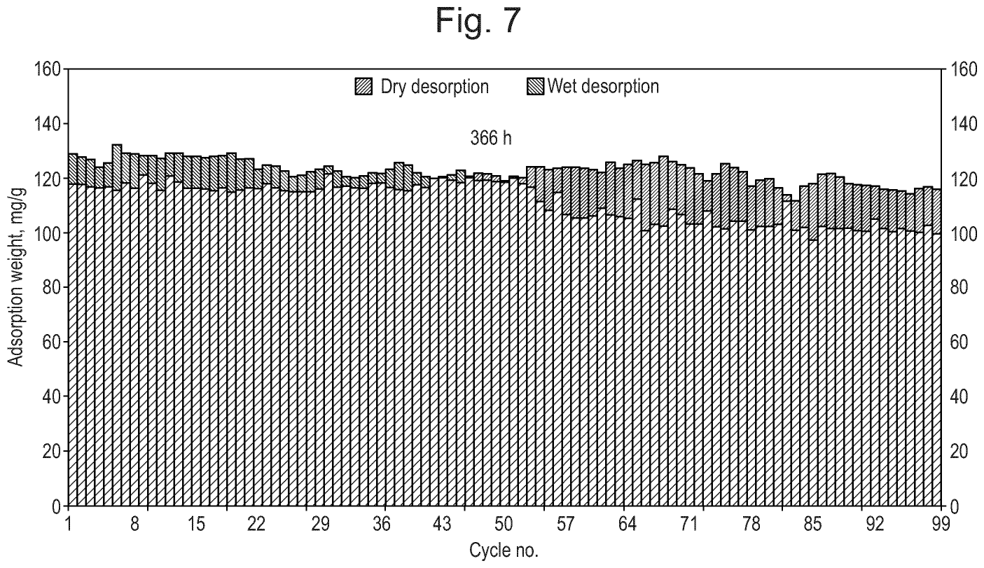

Because the CO₂ quantified in dry conditions based on MS signal was significantly lower than the CO₂ estimated from weight gain (almost half), the MS signal was only used to evaluate the signal ratio from dry and wet adsorption for the same adsorbent amount. The observed findings show no substantial shifting in the maximum temperature, suggesting that the presence of water in the adsorption stage is unlikely to be a significant concern of the required desorption temperature. In addition, a larger CO2 MS peak was obtained when performing the adsorption in wet condition compared to dry one, demonstrating the enhanced CO₂ adsorption in the presence of water. The ratios between the MS signals obtained in wet atmosphere at 40° C.-2.3% H₂O, 40° C.-3% H₂O and 50° C.-3% H₂O, and their dry counterparts are 1.33, 1.24 and 1.25, respectively. Based on these findings, it may be inferred that the CO₂ uptake of AS-3-0.9 can reach at least 2.4-2.6 mmol/g. FIG. 7 depicts the long-term stability of AS-3-0.9 adsorbent in a gas mixture with a comparable composition to the flue gas from a natural gas power plant. In comparison to the previous long-term experiment, this one looks at the effect of oxygen and water in addition to CO2 on the adsorbent properties during the adsorption stage. Based on the obtained findings, no deactivation occurred over 99 cycles (366 h) when the desorption was realized in dry conditions (Ar). However, when desorption was carried out in humid environment (4% H₂O), the stability dropped considerably for the first 60 cycles before plateauing, presumably due to low mechanical stability in presence of water at high temperatures (140° C.). Nevertheless, the presence of water is unwanted in the desorption unit owing to the projected high costs of steam generation and adsorbent drying. Aside from the stability aspect, it's worth noting that the weight gain is the overall weight resulted from both water and CO₂ adsorption. Because the MS-based CO2 quantification is inaccurate, the earlier indicated ratio of 1.25 of wet and dry MS signals can be used to estimate the total CO₂ adsorbed in wet conditions. Considering the CO₂ capacity of 1.82 mmol/g in 5% CO₂ at 50° C., the CO₂ capacity in the presence of 3% H2O will be 2.28 mmol/g (100.1 mg/g). Water adsorption, which contributed to bicarbonate production and/or merely as physisorbed water, accounts for the remaining 20 mg/g (1.1 mmol/g).

The findings in FIGS. 6 and 7 clearly indicate the AS-3-0.9 adsorbent's excellent thermal and chemical stability, which is an important advantage of sorbents according to embodiments. Although impregnation-based adsorbents such as PEI, TEPA, PEHA, and diethanolamine possess remarkable CO2 capacity because of their high amine sites density, their long-term thermal stability is poor especially when regeneration is performed at temperatures over 75° C. [Ref: 62]. Liu et al. [Ref: 63] studied the PEI (MW=800)-MCF's stability by performing desorption at 105° C. for 10 min over 50 cycles and the adsorbent lost 6.9% of its initial adsorption capacity. Chen et al. [Ref: 64] impregnated PEI (600) on HMS and the adsorbent's capacity dropped with 2% after 4 TSA cycles. The use of high molecular weight PEI combined with a low desorption temperature is required to maintain thermal stability. Zhang et al. [Ref: 65] used a PEI (Mₙ=25000) on nano-silica and its capacity was maintained for 180 cycles by performing desorption at 55° C., however the capacity was 2.35 mmol/g in 10% CO₂ and the desorption lasted for 15 min and did not accomplish 100% regeneration. When it comes to the grafting-based adsorbents, the adsorption capacity is lower compared to impregnation-based ones, however the thermal stability is not an issue up to 120° C. [Ref: 17, 35, 41, 48, 66]. At this point, considering the trade-off between adsorbents' CO₂ capacity and stability, both classes, impregnation and grating-based adsorbents, are limited to an average working capacity of 2.5 mmol/g in dry conditions. From the chemical stability point of view, primary amines were found to be more resistant to oxygen atmosphere than secondary and primary-secondary combinations up to 90° C. [Ref: 67]. However, because the secondary amine-based adsorbent according to embodiments performs better at 40° C., oxidative degradation is not an issue, especially that Heydari-Gorji et al. [Ref: 67] found it to be stable up to 70° C. When it comes to chemical stability in CO2-rich atmosphere, primary and primary-secondary amine combinations exhibit very poor resistance, particularly under desorption conditions planned for the adsorbent developed by the study of the inventors (des: 100% CO₂ and t>120° C.) [Ref: 36]. In this case, the secondary amine-based adsorbent is extremely stable even at temperatures as high as 145° C.

### Calorimetry

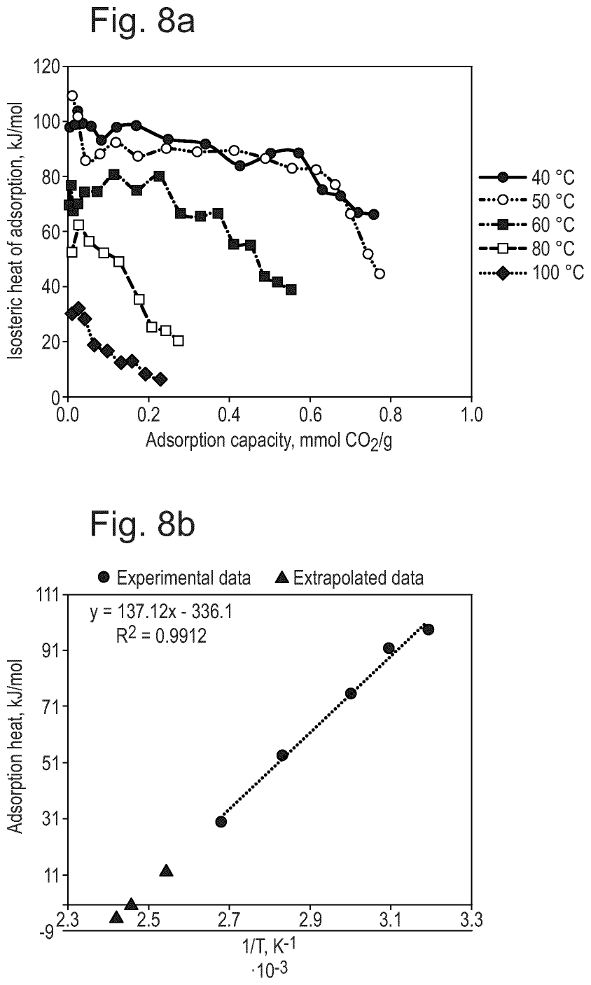

The isosteric heats of adsorption within the temperature interval of 40-100° C. of AS-3-0.9 sorbent are illustrated in the FIG. 8a. It can be noticed that upon increasing the temperature from 40 to 100° C. the heat of adsorption is decreasing from 98 to 31 KJ/mol. By averaging the initial isosteric heats of adsorption points (low CO2 loadings) at each temperature value and plotting against the inverse of the absolute temperature, a linear relationship was obtained (FIG. 8b). Based on fitted tread line, the adsorption heat at 120, 134 and 140° C. were estimated. The net zero adsorption heat was estimated at 134° C. calculated. The decrease in the adsorption heat is clearly contrast to the aqueous amine based solvents where increasing the temperature resulted in larger adsorption heats observed by Arshad et al. [Ref: 68] and Kim et al. [Ref: 69], and adsorption heat more than 150 KJ/mol CO2 was observed. The inventors study presents a very important finding which shows that in case of surface-fixed amine sorbents (e.g., AS-3-0.9) only sensible heat is required and no extra energy (adsorption energy) to reverse the amine-CO2 reaction. The huge difference in the temperature dependence of the adsorption heat should be related to the molecule movement with temperatures. The molecular movement in 3D involves translation, rotation, and vibration movement. In the liquid phase, temperature changes does not result in a significant change in degree of the freedom of the CO2 molecules. When CO2 adsorbed on the solid surface, some degree of the freedom of the movement will be lost, such as translation movement, where 3D molecules become 2D or 1D molecules. With increasing temperature, the vibration frequency significantly increases in 2D or 1D molecule. These freedom changes can be accounted by the entropy change. In order to validate these hypothesises, the entropy change where estimated based on the Langmuir adsorption isothermal equation. The equilibrium constant K was obtained by fitting the Langmuir model to the experimental adsorption isotherm at each temperature. The entropy changes at certain temperature is then estimated from the K and measured adsorption heat (details can be found in supplementary information). A more significant change in entropy change was found with increasing temperature. Based on the statistic thermodynamics, the total entropy can be partitioned into the contribution of translation, rotation, and vibration, and electronic ground state. Herein, the amine compound is fixed to the solid, the freedom of amine is relatively small, and can be considered as solid surface. When the CO2 attaches to the amine group, the bond resumes mostly to vibration, and exposing it to higher temperatures, the vibration frequency intensifies, so it weakens the bond between amine group and CO2 and even breaks the bond without needs of extra energy. When the amine compound is in a liquid form and the amine-CO2 bond vibration frequency might be compensated by rotation and translation movements, which does not weaken the bond between the amine and CO2. The decrease in the desorption heat is described by the entropy induced enthalpy change. It clearly illustrates the advantages of high temperature such as 140° C. in pure CO₂ compared to low temperature vacuum desorption, in terms of desorption energy. It also paves a new way to rational design of solid sorbents to lower the desorption heat. Overall, this finding contributes to reduce the energy penalty associated with the amine-based solvent CO2 capture system.

### Discussion of Embodiments

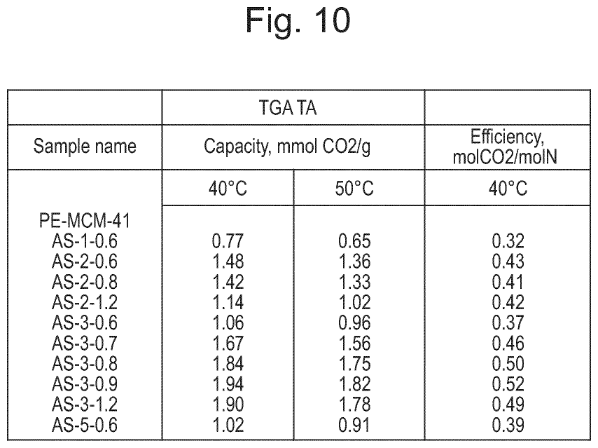

The N-MAPTMS was grafted to PE-MCM-41 that was made by the inventors. The nitrogen content was tuned by manipulating two synthesis variables: N-MAPTMS/PE-MCM-41 (X, mL/g) and H₂O/PE-MCM-41 (Y, mL/g) ratios. The adsorbent obtained with aminosilane/silica and water/silica ratios of 3 and 0.9 mL/g, respectively, performed the best in terms of CO₂ adsorption capacity (1.94 mmol/g at 40° C. and 5% CO₂/N₂) and efficiency (0.52 mol CO₂/mol N at 40° C. and 5% CO₂/N₂) due to the optimum N surface density of 5.25 amine groups/nm². The large surface area and pore volume of the PE-MCM-41 contributed to the formation and well-distribution of a 3D construction of aminosilane inside the porous media, allowing a good diffusion of CO₂ towards the amine sites. The accelerated CO₂ diffusion was noticed from the immediate increase in weight upon switching to 5% CO₂/N₂ flow, thus reaching 90% of the total capacity corresponding to 40° C. in less than 3 minutes. Furthermore, the AS-3-0.9 manifested a good CO2 capacity at P_{CO2}<5 kPa, reaching 1.88, 1.73 and 0.94 mmolCO₂/g at P_{CO2} of 3, 1 and 0.03 kPa, respectively, and 40° C., placing it far above most literature adsorbents (see Supplementary Table 2 in FIG. 10). Another aspect carried out in this study was the thermal and chemical stability of the AS-3-0.9. The adsorbent showed excellent thermo-chemical stability over 205 TSA cycles in 80% CO₂ and 50-145° C., indicating the presence of the covalent attachment of aminosilane to the silica surface and no sign of urea's species. The sorbent also showed a good long-term stability in a gas mixture with similar composition to the flue gas from a natural gas power plant, which includes O₂ and H₂O besides CO₂. The simple synthesis of PE-MCM-41 silica support, as well as the straightforward grafting of aminosilane on the silica surface with no need of amine modification unlike the PEI [Ref: 24], TEPA [Ref: 26], together with the high adsorbent's CO₂ capacity and flexible working conditions, allows the method to be readily scaled up.

In addition, the sorbent presents no heat of adsorption at temperature as high as 140° C., thus requiring only the sensible heat for the desorption unit, so resulting in a reduction of energy penalty.

Comparison with Prior Sorbents

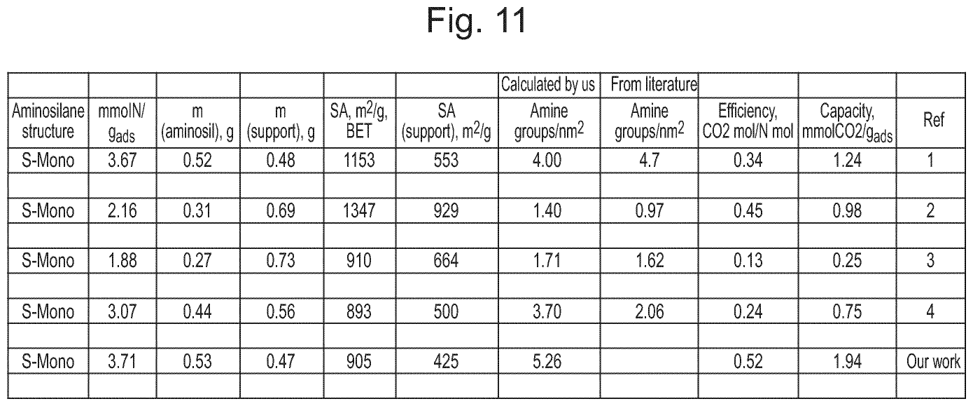

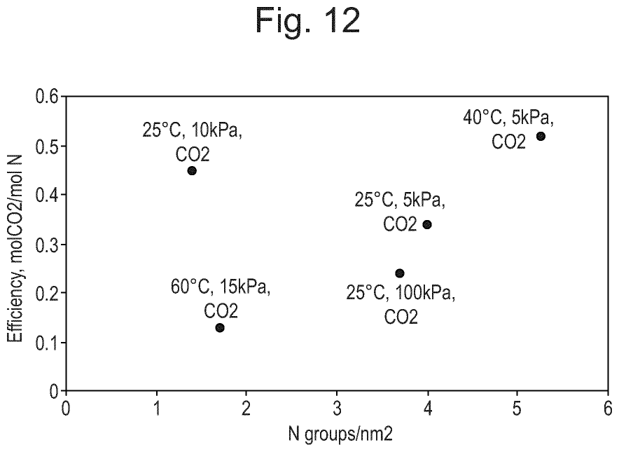

Table 3 in FIG. 11 provides a comparison of a sorbent of the invention (AS-3-0.9) with sorbents prepared previously (Ref 1 corresponds to [Ref: 69], Ref 2 corresponds to [Ref: 48], Ref 3 corresponds to [Ref: 70], Ref 4 corresponds to [Ref: 47]. The properties provided in the Table include amine group density (calculated according to the method within this document), amine group density (literature value), efficiency and capacity. It is demonstrated that AS-3-0.9 has the highest amine group density, efficiency and capacity of the sorbents.

### Methods and Materials of Embodiments

Hexadecyltrimethylammonium bromide (CTAB; ≥98%, MW=364.45 g/mol, Sigma-Aldrich), ammonia solution (25%, AnalaR NORMAPUR®, WVR Chemicals), tetraethyl orthosilicate (TEOS; ≥99% (GC), MW=208.33 g/mol, Sigma-Aldrich), and distilled water were used for the synthesis of PE-MCM-41. N-methylaminopropyltrimethoxysilane (N-MAPTMS; 97% min, Gelest), toluene (≥99.5%, MERCK), and distilled water were used for the covalently bonding of the N-MAPTMS to the surface of PE-MCM-41. Ultra-high-quality gases were purchased from Linde: N₂ (5.0), CO₂ (5.3), 0, 1, 1 and 10% CO₂ balance N₂ (uncertainty ±2%), Ar (5.0), synthetic air (5.0, 21% O₂). All chemicals and gases were used without prior purification.

### PE-MCM-41 Synthesis

The PE-MCM-41 was prepared according to the novel procedure described by [Ref: 45]. Briefly, PE-MCM-41 was synthesized at 25° C. using a stirring-heating plate. A vigorous mixing of 400 rpm was maintained for the entire procedure. In a typical synthesis, 4 g of CTAB, a structure directing agent, was mixed with 240 mL of water in a 500 ml beaker. The stirring time of 30 min was considered enough to obtain a homogeneous dispersion of the surfactant. As a next step, 20 mL of TEOS was added dropwise to the CTAB-water mixture (10 min), followed by a mixing time of 5 min. Then, to catalyze the hydrolyzation and condensation of TEOS, a mineralizing agent, 2 mL of 25% ammonia solution was finally added. After addition of ammonia solution, the mixture started to form a gel which was kept at the same conditions for 19 h. To prevent the loss of aqueous ammonia throughout the sol-gel transition reaction, the beaker was coated with a parafilm layer. The white solid product was repeatedly filtered and washed with copious amount of distilled water, and then subjected to an overnight period of drying at room temperature in a well-ventilated area. The surfactant was removed by calcination in a static air atmosphere using a muffle furnace. First, the solid was dried at 150° C. for 2 h to completely remove the water, and then heated up to 550° C. with a heating rate of 1° C./min and maintained there for 5 h. After cooling down, the mesostructured product was stored in a capped glass vial and placed in a glass desiccator jar with the bottom volume filled with silica gel beads as desiccant material. This was done with the purpose of keeping the calcined PE-MCM-41 away from moisture.

### N-MAPTMS Grafting onto PE-MCM-41 of Embodiments

N-MAPTMS was covalently bonded to the surface of PE-MCM-41 by following the wet grafting approach reported by [Refs: 19, 35, 66]. A silica amount within the range of 0.36-0.38 g was loaded into a 100 mL Erlenmeyer flask, followed by the addition of 50 mL toluene. A specific amount of water was added dropwise, while vigorously mixing (400 rpm) at 25° C. The solution was stirred for 3 h to allow the water to infiltrate into the porous structure of silica. Afterwards, a certain volume of N-MAPTMS was dripped to the mixture and the flask was immersed in an oil bath and rapidly heated up to 85° C. The suspension was stirred and kept under reflux for 12 h. The N-MAPTMS-grafted PE-MCM-41 was repeatedly vacuum filtered and washed with aliquots of toluene, and then dried at 50° C. for 6 h. The dried products were stored in capped glass vials. The prepared samples are labeled as AS-X-Y, where AS refers to the amino-grafted silica sample, followed by the aminosilane (mL)/silica (g) ratio, X, and water (mL)/silica ratio (g), Y.

### Material Characterization of Embodiments

### N2-Physisorption of Embodiments

N2 adsorption-desorption isotherms were measured at −196° C. using a Micromeritics TriStar 3000 apparatus. Prior to adsorption, the PE-MCM-41 and AS-X-Y samples were degassed in a VacPrep 061 Degasser under vacuum overnight at 200 and 80° C., respectively. 80° C. temperature was chosen for grafted samples to minimize the degradation of amines. The BET (Brunauer-Emmett-Teller) model was used to calculate the specific surface area within the relative pressure range of 0.05 to 0.3. The pore size distribution was calculated using the BJH (Barrett-Joyner-Halenda) approach. The full surface saturation was assumed to be at a relative pressure (P/P₀) of 0.97, which was considered for the estimation of the total pore volume.

### XRD of Embodiments

X-ray diffraction (XRD) patterns of MCM-41 and AS-X-Y samples were measured on a Bruker D8 Focus operating under CuKα radiation (1.54 Å) at 40 kV and 40 mA. The diffractograms were acquired in 2θ range of 1.5-10° at a step size of 0.02° and step time of 6 s. A divergence slit with an aperture of 0.1 mm was used.

### TGA of Embodiments

The N-MAPTMS amount on AS-X-Y samples was quantified by thermogravimetric analysis (TGA) on a TA-Q500 apparatus. The temperature-gas profile involved two steps: (i) sample pre-treatment under N2 flow at 150° C. for 1 h to remove moisture, and (ii) a heating ramp of 5° C./min to 800° C. with a dwell of 1 h under 14.7 vol % O2 in N2 to remove the organic content. The weight loss obtained in the step (ii) was used to calculate the grafted amount of aminosilane by assuming a monodentate coordination of methoxy groups with the available hydroxyl groups on the silica surface and of other aminosilane.

Considering this, the mmol of N was simply determined by dividing the weight loss to 83 g/mol. The weight loss of PE-MCM-41 was also determined under the same temperature-gas profile.

### CO2 Adsorption-Desorption Experiments. of Embodiments

The CO2 capacities of all samples were measured by thermogravimetric analysis (TGA) on a TA-Q500 apparatus, using N2 (5.0) as a balance purge gas. A 10% CO₂ balance N2 gas was used as a sample purge gas and the total gas flow was maintained at 100 mL/min.

Approximately 10 mg of sample was used for all measurements. Before exposing the sample to a CO2-N2 mixture, the AS-X-Y samples were activated by performing a degassing step under N₂ flow at 120° C. for 1 h to remove adsorbed species (e.g., CO2, H2O, solvent traces). The temperature profile followed then a cooling down step to a desired temperature and a 5% CO2 balance N2 mixture was switched on and maintained for 1 h. The CO2 adsorption step was carried out at 40 and 50° C. with a desorption step in between performed at 100° C. for 10 min under N2 flow. The same instrument was used to record the isotherms of AS-3-0.9 sample at 40, 50 and 60° C. within a pressure range of 0.02-80 kPa. For this purpose, 0.1, 1 and 10% CO₂ balance N2 and/or He gas blends were used. Each point of the isotherm was measured for 1 h.

### Multicycle Stability of Embodiments

### Dry Adsorption-Desorption of Embodiments

The stability of AS-3-0.9 sample was examined in dry 80% CO2 balance N2 flow using a TGA-TA-Q500 apparatus. 205 (423 h) adsorption-desorption cycles were carried out under a total flow of 100 mL/min with adsorption-desorption temperatures of 50 and 145° C., respectively. When cooling down to adsorption temperature, the gas was switched from CO2 to N2 to fully remove the CO2 and correctly quantify the adsorption capacity of the next cycle.

### Simulant Flue Gas of Embodiments

The stability of AS-3-0.9 sample was also investigated in a simulant flue gas (5% CO2, 10.5% O2, 3% H2O balance N2 and Ar) as adsorption gas mixture, at 50° C. for 20 min, and 77% CO2 and 4% H2O (in Ar) as desorption gas, at 140° C. for 25 min. 413 and 272 mL/min were the total flows for adsorption and desorption, respectively. The cooling down step was performed under pure Ar. The switching from CO2 to Ar was also necessary to completely remove the adsorbed CO2. To be able to pass a humid gas over the sample, a glass gas washer under 35° C. was used. A constant temperature was maintained with a water bath (Julabo 12). The outline of the gas washer was heated to 50-70° C. to avoid water condensation. A similar stability test was performed by substituting the desorption gas mixture with a 200 mL/min flow of pure Ar (dry desorption). 99 cycles (366 h) were performed for both cases.

Temperature-programmed desorption (TPD) analyses in dry and wet conditions were carried out in a TGA-Linseis coupled with MS detector. 0.1, 1% CO2 balance N₂—He and pure N₂ gases were used for MS calibration. The calibration curve was generated based on the linear relationship between the CO2 concentration and MS signal corresponding to 44 amu. For this purpose, nine CO₂ concentrations were used, resulting in a coefficient of determination, R², of 0.9986. All analyses were performed on AS-3-0.9 sample. Each test was carried out according to the following steps: (i) pre-treatment at 120° C. for 30 min under 200 mL/min Ar, (ii) cooling down to desired temperature (40, 50° C.) under a cooling rate of 1° C./min in 200 mL/min Ar, (iii) switching to 1% CO₂ with/without water and maintaining for 2 h to reach equilibrium, (iv) switching to Ar for 4 min to clean the TGA-MS channels, and (v) heating up to 120° C. with a ramp of 5° C./min in 100 mL/min Ar to release the adsorbed CO₂. The CO₂ released from the adsorbent was quantified based on the MS signal area and the calibration curve. The adsorption step was realized at 40 and 50° C. At 40° C., two TPD tests were performed in 2.3% and 3% H₂O, respectively, while at 50° C. in 3% H₂O. The water was introduced in the sample-containing chamber as described in the simulant flue gas section. A blank test was realized for each type of analysis to correct the MS baseline.

Embodiments include a number of modifications and variations to the above-described processes.

Embodiments include the secondary monoamines that are grafted onto a silica support as described in: ‘CO₂-Induced Degradation of Amine-Containing Adsorbents: Reaction Products and Pathways’; Abdelhamid Sayari, Aliakbar Heydari-Gorji, and Yong Yang; Journal of the American Chemical Society; 2012, 134, pages 13834 to 13842, the entire contents of which are incorporated herein by reference.

All of the components of the reactor system of embodiments are scalable such that implementations of embodiments are appropriate for small, medium and large industrial scale processes.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

Throughout the present document, references to the following documents are made, all of which are incorporated herein by reference:
1 Chiang, P.-C. & Pan, S.-Y. Carbon Dioxide Mineralization and Utilization. (2017).
2 Metz, B., Davidson, O., Coninck, H. d., Loos, M. & Meyer, L. Carbon Dioxide Capture and Storage. (Cambridge University Press, United States of America, New York, 2005).
3 Aaron, D. & Tsouris, C. Separation of CO2 from Flue Gas: A Review. Separation Science and Technology 40, 321-348, doi: 10.1081/SS-200042244 (2005).
4 Pandey, S., Gupta, S., Tomar, A. & Kumar, A. POST COMBUSTION CARBON CAPTURE TECHNOLOGY. (2010).
5 Winter, F., Hrdlicka, J. & Varjani, S. CO2 Separation, Purification and Conversion to Chemicals and Fuels. (2019).
6 D'Alessandro, D. M., Smit, B. & Long, J. R. Carbon dioxide capture: prospects for new materials. Angew Chem Int Ed Engl 49, 6058-6082, doi: 10.1002/anie.201000431 (2010).
7 Dutcher, B., Fan, M. & Russell, A. G. Amine-Based CO2 Capture Technology Development from the Beginning of 2013—A Review. ACS Applied Materials & Interfaces 7, 2137-2148, doi: 10.1021/am507465f (2015).
8 Sayari, A., Belmabkhout, Y. & Serna-Guerrero, R. Flue gas treatment via CO2 adsorption. Chemical Engineering Journal 171, 760-774, doi: https://doi.org/10.1016/j.cej.2011.02.007 (2011).
9 Zhang, W. et al. Parametric study on the regeneration heat requirement of an amine-based solid adsorbent process for post-combustion carbon capture. Applied Energy 168, 394-405, doi: 10.1016/j.apenergy.2016.01.049 (2016).
10 Li, K., Jiang, J., Yan, F., Tian, S. & Chen, X. The influence of polyethyleneimine type and molecular weight on the CO2 capture performance of PEI-nano silica adsorbents. Applied Energy 136, 750-755, doi: 10.1016/j.apenergy.2014.09.057 (2014).
11 Heydari-Gorji, A., Belmabkhout, Y. & Sayari, A. Polyethylenimine-Impregnated Mesoporous Silica: Effect of Amine Loading and Surface Alkyl Chains on CO2 Adsorption. Langmuir 27, 12411-12416, doi: 10.1021/la202972t (2011).
12 Ji, C. et al. Pentaethylenehexamine-Loaded Hierarchically Porous Silica for CO(2) Adsorption. Materials (Basel) 9, doi: 10.3390/ma9100835 (2016).
13 Wei, L., Jing, Y., Gao, Z. & Wang, Y. Development of a pentaethylenehexamine-modified solid support adsorbent for CO2 capture from model flue gas. Chinese Journal of Chemical Engineering 23, 366-371, doi: 10.1016/j.cjche.2014.11.021 (2015).
14 Sanz, R., Calleja, G., Arencibia, A. & Sanz-Pérez, E. S. Development of high efficiency adsorbents for CO2 capture based on a double-functionalization method of grafting and impregnation. Journal of Materials Chemistry A 1, 1956-1962, doi: 10.1039/C2TA01343F (2013).
15 Ojeda, M. et al. Novel Amine-impregnated Mesostructured Silica Materials for CO2 Capture. Energy Procedia 114, 2252-2258, doi: 10.1016/j.egypro.2017.03.1362 (2017).
16 Qi, G. et al. High efficiency nanocomposite sorbents for CO2 capture based on amine-functionalized mesoporous capsules. Energy & Environmental Science 4, 444-452, doi: 10.1039/C0EE00213E (2011).
17 Sayari, A., Belmabkhout, Y. & Da'na, E. CO2 Deactivation of Supported Amines: Does the Nature of Amine Matter? Langmuir 28, 4241-4247, doi: 10.1021/1a204667v (2012).
18 Harlick, P. J. E. & Sayari, A. Applications of Pore-Expanded Mesoporous Silicas. 3. Triamine Silane Grafting for Enhanced CO2 Adsorption. Industrial & Engineering Chemistry Research 45, 3248-3255, doi: 10.1021/ie051286p (2006).
19 Harlick, P. J. E. & Sayari, A. Applications of Pore-Expanded Mesoporous Silica. 5. Triamine Grafted Material with Exceptional CO2 Dynamic and Equilibrium Adsorption Performance. Industrial & Engineering Chemistry Research 46, 446-458, doi: 10.1021/ie060774+ (2007).
20 Knowles, G. P. & Chaffee, A. L. Aminopropyl-Functionalized Silica CO2 Adsorbents via Sonochemical Methods. Journal of Chemistry 2016, 1070838, doi: 10.1155/2016/1070838 (2016).
21 Qi, G., Fu, L. & Giannelis, E. P. Sponges with covalently tethered amines for high-efficiency carbon capture. Nat Commun 5, 5796, doi: 10.1038/ncomms6796 (2014).
22 He, H. et al. Preparation and Properties of A Hyperbranch-Structured Polyamine adsorbent for Carbon Dioxide Capture. Scientific Reports 7, 3913, doi: 10.1038/s41598-017-04329-w (2017).
23 Wang, J. et al. Recent advances in solid sorbents for CO2 capture and new development trends. Energy & Environmental Science 7, 3478-3518, doi: 10.1039/C4EE01647E (2014).
24 Choi, W. et al. Epoxide-functionalization of polyethyleneimine for synthesis of stable carbon dioxide adsorbent in temperature swing adsorption. Nature Communications 7, 12640, doi: 10.1038/ncomms12640 (2016).
25 Yamada, H., Chowdhury, F. A., Fujiki, J. & Yogo, K. Enhancement Mechanism of the CO2 Adsorption-Desorption Efficiency of Silica-Supported Tetraethylenepentamine by Chemical Modification of Amino Groups. ACS Sustainable Chemistry & Engineering 7, 9574-9581, doi: 10.1021/acssuschemeng.9b01064 (2019).
26 Guo, M., Liang, S., Liu, J., Jin, J. & Mi, J. Epoxide-Functionalization of Grafted Tetraethylenepentamine on the Framework of an Acrylate Copolymer as a CO2 Sorbent with Long Cycle Stability. ACS Sustainable Chemistry & Engineering 8, 3853-3864, doi: 10.1021/acssuschemeng.9b07318 (2020).
27 Hamdy, L. B., Wakeham, R. J., Taddei, M., Barron, A. R. & Andreoli, E. Epoxy Cross-Linked Polyamine CO2 Sorbents Enhanced via Hydrophobic Functionalization. Chemistry of Materials 31, 4673-4684, doi: 10.1021/acs.chemmater.9b00574 (2019).
28 Belmabkhout, Y., Serna-Guerrero, R. & Sayari, A. Adsorption of CO2-Containing Gas Mixtures over Amine-Bearing Pore-Expanded MCM-41 Silica: Application for Gas Purification. Industrial & Engineering Chemistry Research 49, 359-365, doi: 10.1021/ie900837t (2010).
29 Drage, T. C. et al. Materials challenges for the development of solid sorbents for post-combustion carbon capture. J. Mater. Chem. 22, 2815-2823, doi: 10.1039/c2jm12592g (2012).
30 Serna-Guerrero, R., Da′na, E. & Sayari, A. New Insights into the Interactions of CO2 with Amine-Functionalized Silica. Industrial & Engineering Chemistry Research 47, 9406-9412, doi: 10.1021/ie801186g (2008).
31 Bollini, P., Didas, S. A. & Jones, C. W. Amine-oxide hybrid materials for acid gas separations. Journal of Materials Chemistry 21, 15100-15120, doi: 10.1039/C1JM12522B (2011).
32 Xiaochun Xu, Chunshan Song, Bruce G. Miller & Scaroni, A. W. Influence of Moisture on CO2 Separation from Gas Mixture by a Nanoporous Adsorbent Based on Polyethylenimine-Modified Molecular Sieve MCM-41. Ind. Eng. Chem. Res. 44, 8113-8119 (2005).
33 Xiaoliang Ma, Xiaoxing Wang & Song*, C. “Molecular Basket” Sorbents for Separation of CO2 and H2S from Various Gas Streams. JACS 131, 5777-5783 (2009).
34 Li, K., Jiang, J., Tian, S., Yan, F. & Chen, X. Polyethyleneimine-nano silica composites: a low-cost and promising adsorbent for CO2 capture. Journal of Materials Chemistry A 3, 2166-2175, doi: 10.1039/C4TA04275A (2015).
35 Anyanwu, J.-T., Wang, Y. & Yang, R. T. Amine-Grafted Silica Gels for CO2 Capture Including Direct Air Capture. Industrial & Engineering Chemistry Research 59, 7072-7079, doi: 10.1021/acs.iecr.9b05228 (2020).
36 Sayari, A., Heydari-Gorji, A. & Yang, Y. CO2-Induced Degradation of Amine-Containing Adsorbents: Reaction Products and Pathways. Journal of the American Chemical Society 134, 13834-13842, doi: 10.1021/ja304888a (2012).
37 Feng, X. et al. Functionalized Monolayers on Ordered Mesoporous Supports. Science 276, 923-926, doi: 10.1126/science.276.5314.923 (1997).
38 Brochier Salon, M.-C., Bardet, M. & Belgacem, M. N. Solvolysis-hydrolysis of N-bearing alkoxysilanes: Reactions studied with 29Si NMR. Silicon Chemistry 3, 335-350, doi: 10.1007/s11201-008-9036-4 (2008).
39 Brochier Salon, M.-C. & Belgacem, M. N. Competition between hydrolysis and condensation reactions of trialkoxysilanes, as a function of the amount of water and the nature of the organic group. Colloids and Surfaces A: Physicochemical and Engineering Aspects 366, 147-154, doi: https://doi.org/10.1016/j.colsurfa.2010.06.002 (2010).
40 Brochier Salon, M.-C. & Belgacem, M. N. Hydrolysis-Condensation Kinetics of Different Silane Coupling Agents. Phosphorus, Sulfur, and Silicon and the Related Elements 186, 240-254, doi: 10.1080/10426507.2010.494644 (2011).
41 Linneen, N. N., Pfeffer, R. & Lin, Y. S. CO2 adsorption performance for amine grafted particulate silica aerogels. Chemical Engineering Journal 254, 190-197, doi: https://doi.org/10.1016/j.cej.2014.05.087 (2014).
42 Kim, D. H., Celedonio, J. & Ko, Y. S. A Study on Grafting Efficiency of Amine and CO2 Sorption Behavior Inside Amorphous Silica. Topics in Catalysis 60, 706-713, doi: 10.1007/s11244-017-0786-0 (2017).
43 Kiatphuengporn, S., Chareonpanich, M. & Limtrakul, J. Effect of unimodal and bimodal MCM-41 mesoporous silica supports on activity of Fe—Cu catalysts for CO2 hydrogenation. Chemical Engineering Journal 240, 527-533, doi: https://doi.org/10.1016/j.cej.2013.10.090 (2014).
44 Shan, W. et al. Aminopropyl-grafted various silica mesostructures for adsorption of molybdenum ions from Re-containing effluent. Adsorption 22, 859-869, doi: 10.1007/s10450-016-9777-x (2016).
45 Loganathan, S., Tikmani, M. & Ghoshal, A. K. Novel Pore-Expanded MCM-41 for CO2 Capture: Synthesis and Characterization. Langmuir 29, 3491-3499, doi: 10.1021/la400109j (2013).
46 Liu, Z., Teng, Y. & Zhang, K. Evaluation of Optimal Pore Size of (3-Aminopropyl)triethoxysilane Grafted MCM-41 for Improved CO<sub>2</sub> Adsorption. Journal of Chemistry 2015, 608265, doi: 10.1155/2015/608265 (2015).
47 Ko, Y. G., Shin, S. S. & Choi, U. S. Primary, secondary, and tertiary amines for CO2 capture: Designing for mesoporous CO2 adsorbents. Journal of Colloid and Interface Science 361, 594-602, doi: https://doi.org/10.1016/j.jcis.2011.03.045 (2011).
48 Zelenak, V., Halamova, D., Gaberova, L., Bloch, E. & Llewellyn, P. Amine-modified SBA-12 mesoporous silica for carbon dioxide capture: Effect of amine basicity on sorption properties. Microporous and Mesoporous Materials 116, 358-364, doi: https://doi.org/10.1016/j.micromeso.2008.04.023 (2008).
49 Hori, K. et al. Effect of pore size, aminosilane density and aminosilane molecular length on CO2 adsorption performance in aminosilane modified mesoporous silica. Microporous and Mesoporous Materials 246, 158-165, doi: https://doi.org/10.1016/j.micromeso.2017.03.020 (2017).
50 Serna-Guerrero, R., Belmabkhout, Y. & Sayari, A. Further investigations of CO2 capture using triamine-grafted pore-expanded mesoporous silica. Chemical Engineering Journal 158, 513-519, doi: https://doi.org/10.1016/j.cej.2010.01.041 (2010).
51 Zeleňák, V. et al. Amine-modified ordered mesoporous silica: Effect of pore size on carbon dioxide capture. Chemical Engineering Journal 144, 336-342, doi: https://doi.org/10.1016/j.cej.2008.07.025 (2008).
52 Vu, Q. T., Yamada, H. & Yogo, K. Effects of Amine Structures on Oxidative Degradation of Amine-Functionalized Adsorbents for CO2 Capture. Industrial & Engineering Chemistry Research 60, 4942-4950, doi: 10.1021/acs.iecr.0c05694 (2021).
53 Vu, Q. T., Yamada, H. & Yogo, K. Exploring the Role of Imidazoles in Amine-Impregnated Mesoporous Silica for CO2 Capture. Industrial & Engineering Chemistry Research 57, 2638-2644, doi: 10.1021/acs.iecr.7b04722 (2018).
54 Sanz, R., Calleja, G., Arencibia, A. & Sanz-Pérez, E. S. CO2 adsorption on branched polyethyleneimine-impregnated mesoporous silica SBA-15. Applied Surface Science 256, 5323-5328, doi: 10.1016/j.apsusc.2009.12.070 (2010).
55 Liu, Y. et al. Pentaethylenehexamine loaded SBA-16 for CO 2 capture from simulated flue gas. Powder Technology 318, 186-192, doi: 10.1016/j.powtec.2017.06.002 (2017).
56 Wei, L., Gao, Z., Jing, Y. & Wang, Y. Adsorption of CO2 from Simulated Flue Gas on Pentaethylenehexamine-Loaded Mesoporous Silica Support Adsorbent. Industrial & Engineering Chemistry Research 52, 14965-14974, doi: 10.1021/ie402162x (2013).
57 Ma, J., Liu, Q., Chen, D., Zhou, Y. & Wen, S. Carbon dioxide adsorption using amine-functionalized mesocellular siliceous foams. Journal of Materials Science 49, 7585-7596, doi: 10.1007/s10853-014-8467-x (2014).
58 Hao, S., Chang, H., Xiao, Q., Zhong, Y. & Zhu, W. One-Pot Synthesis and CO2 Adsorption Properties of Ordered Mesoporous SBA-15 Materials Functionalized with APTMS. The Journal of Physical Chemistry C 115, 12873-12882, doi: 10.1021/jp200252u (2011).
59 Li, K. et al. Research on Urea Linkages Formation of Amine Functional Adsorbents During CO2 Capture Process: Two Key Factors Analysis, Temperature and Moisture. The Journal of Physical Chemistry C 120, 25892-25902, doi: 10.1021/acs.jpcc.6b08788 (2016).
60 Sayari, A. & Belmabkhout, Y. Stabilization of Amine-Containing CO2 Adsorbents: Dramatic Effect of Water Vapor. Journal of the American Chemical Society 132, 6312-6314, doi: 10.1021/ja1013773 (2010).
61 Huang, H. Y., Yang, R. T., Chinn, D. & Munson, C. L. Amine-Grafted MCM-48 and Silica Xerogel as Superior Sorbents for Acidic Gas Removal from Natural Gas. Industrial & Engineering Chemistry Research 42, 2427-2433, doi: 10.1021/ie020440u (2003).
62 Chen, C., Zhang, S., Row, K. H. & Ahn, W.-S. Amine-silica composites for CO2 capture: A short review. Journal of Energy Chemistry 26, 868-880, doi: https://doi.org/10.1016/j.jechem.2017.07.001 (2017).
63 Liu, Z., Pudasainee, D., Liu, Q. & Gupta, R. Post-combustion CO2 capture using polyethyleneimine impregnated mesoporous cellular foams. Separation and Purification Technology 156, 259-268, doi: https://doi.org/10.1016/j.seppur.2015.10.009 (2015).
64 Chen, C., Son, W.-J., You, K.-S., Ahn, J.-W. & Ahn, W.-S. Carbon dioxide capture using amine-impregnated HMS having textural mesoporosity. Chemical Engineering Journal 161, 46-52, doi: https://doi.org/10.1016/j.cej.2010.04.019 (2010).
65 Zhang, H., Goeppert, A., Prakash, G. K. S. & Olah, G. Applicability of linear polyethylenimine supported on nano-silica for the adsorption of CO2 from various sources including dry air. RSC Advances 5, 52550-52562, doi: 10.1039/C5RA05428A (2015).
66 Jahandar Lashaki, M. & Sayari, A. CO2 capture using triamine-grafted SBA-15: The impact of the support pore structure. Chemical Engineering Journal 334, 1260-1269, doi: https://doi.org/10.1016/j.cej.2017.10.103 (2018).
67 Heydari-Gorji, A., Belmabkhout, Y. & Sayari, A. Degradation of amine-supported CO2 adsorbents in the presence of oxygen-containing gases. Microporous and Mesoporous Materials 145, 146-149, doi: https://doi.org/10.1016/j.micromeso.2011.05.010 (2011).
68 Sayari, A., Belmabkhout, Y. & Da′na, E. CO2 Deactivation of Supported Amines: Does the Nature of Amine Matter? Langmuir 28, 4241-4247, doi: 10.1021/la204667v (2012).
69 Hiyoshi, N., Yogo, K. & Yashima, T. Adsorption characteristics of carbon dioxide on organically functionalized SBA-15. Microporous and Mesoporous Materials 84, 357-365, doi: https://doi.org/10.1016/j.micromeso.2005.06.010 (2005).

1. A solid sorbent for use in a carbon dioxide capture process, the sorbent comprising:
a solid sorbent support that comprises pores; and
secondary amines that are covalently attached to the solid sorbent support, wherein the secondary amines are confined inside the pores of the solid sorbent support and are present at a density that is greater than 4 amine groups/nm².

2. The solid sorbent according to claim 1, wherein the solid sorbent support is a silica sorbent support.

3. The solid sorbent according to claim 2, wherein the silica sorbent support is a pore expanded mesoporous silica sorbent support, and is preferably PE-MCM-41.

4. The solid sorbent according to any one of claims 1 to 3, wherein the secondary amines that are covalently attached to the solid sorbent support have structures according to formula (I): 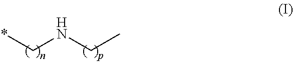 [SMILES: *CNCC]
wherein:
* denotes the point of attachment to an atom (preferably Si) that is covalently attached to, or forms part of, the solid sorbent support,
n is from 1 to 6, and
p is from 0 to 5.

5. The solid sorbent according to claim 4, wherein the secondary amines that are covalently attached to the solid sorbent support have structures according to formula (I′): 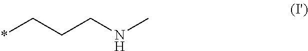 [SMILES: *CCCNC]
wherein:
* denotes the point of attachment to an atom (preferably Si) that is covalently attached to, or forms part of, the solid sorbent support.

6. The solid sorbent according to any one of claims 1 to 6, wherein the secondary amines are present at a density that is greater than 4.5 amine groups/nm², preferably greater than 5 amine groups/nm².

7. The solid sorbent according to claim 1, wherein:
the solid sorbent support is a silica sorbent support that is pore expanded MCM-41;
the secondary amines that are covalently attached to the solid sorbent support have structures according to formula (I′): 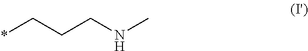 [SMILES: *CCCNC]
wherein:
* denotes the point of attachment to an atom (preferably Si) that is covalently attached to, or forms part of, the solid sorbent support; and
the secondary amines are confined inside the pores of the solid sorbent support and are present at a density that is more than 5 amine groups/nm² and less than 6 amine groups/nm².

8. The solid sorbent according to any one of claims 1 to 7, wherein the secondary amines are confined inside the pores of the solid sorbent such the solid sorbent has a ΔV/V_{amino-grafted} ratio of from 0.7 to 1.1, preferably of from 0.85 to 1.1, and further preferably of from 0.9 to 1.05.

9. A method of preparing a solid sorbent for use in a carbon dioxide capture process, the sorbent comprising:
a solid sorbent support that comprises pores; and
secondary amines that are covalently attached to the solid sorbent support and are confined inside the pores of the solid sorbent support; the method comprising:
the step of contacting a solid sorbent support that comprises pores with
(a) a compound, wherein the compound comprises a secondary amine group and a group capable of forming a covalent bond to the solid sorbent support; and
(b) water; and wherein
the compound is present in an amount of from 2 to 6 mL of compound per gram of solid sorbent support; and
the water is present in an amount of from 0.5 to 1.5 mL of water per gram of solid sorbent support.

10. The method according to claim 9, wherein the solid sorbent support is a silica sorbent support.

11. The method according to claim 10, wherein the silica sorbent support is a pore expanded mesoporous silica sorbent support, and is preferably PE-MCM-41.

12. The method according to any one of claims 9 to 11, wherein the solid sorbent support has:
(d) a surface area of from around 700 to around 1100 m²/g, and/or
(e) a pore volume of from around 1.2 to around 2.0 cm³/g, and/or
(f) a mean pore diameter of from around 5 to around 10 nm.

13. The method according to any one of claims 9 to 12, wherein the compound is an aminosilane of formula (II) 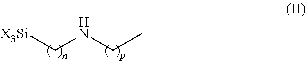
wherein:
each X is independently a leaving group, wherein, preferably, each X is independently a C₁-C₆ alkoxy group;
n is from 1 to 6; and
p is from 0 to 5.

14. The method according to claim 13, wherein the aminosilane is N-methylaminopropyltrimethoxysilane.

15. The method according to any one of claims 9 to 14, wherein:
the contacting step is carried out in the presence of toluene,
the toluene is present in an amount of from 140 to 417 mL of toluene per gram of solid sorbent support; and, either:
(a) the compound is present in an amount of 2.0 to 2.4 mL of compound per gram of solid sorbent support, and
the water is present in an amount of from 0.6 to 0.9 mL of water per gram of solid sorbent support; or
(b) the compound is present in an amount of 2.5 to 5 mL of compound per gram of solid sorbent support, and
the water is present in an amount of from 0.7 to 1.3 mL of water per gram of solid sorbent support.

16. The method according to claim 15, wherein:
the compound is present in an amount of around 3 mL of compound per gram of solid sorbent support;
the water is present in an amount of around 0.9 mL of water per gram of solid sorbent support; and
the toluene is present in an amount of around 140 mL of toluene per gram of solid sorbent support.

17. The method according to claim 9, wherein:
the solid sorbent support is a solid silica sorbent support that is pore expanded MCM-41;
the compound is N-methylaminopropyltrimethoxysilane;
the contacting step is carried out in the presence of toluene,
the toluene is present in an amount of from 140 to 417 mL of toluene per gram of solid sorbent support; and, either:
(a) the compound is present in an amount of 2.0 to 2.4 mL of compound per gram of solid sorbent support, and
the water is present in an amount of from 0.6 to 0.9 mL of water per gram of solid sorbent support; or
(b) the compound is present in an amount of 2.5 to 5 mL of compound per gram of solid sorbent support, and
the water is present in an amount of from 0.7 to 1.3 mL of water per gram of solid sorbent support.

18. The method according to any one of claims 9 to 17, wherein, in the contacting step, secondary amines are confined inside the pores of the solid sorbent such the solid sorbent has a ΔV/V_{amino-grafted} ratio of from 0.7 to 1.1, preferably of from 0.85 to 1.1, and further preferably of from 0.9 to 1.05.

19. A solid sorbent for use in a carbon dioxide capture process, the sorbent comprising:
a solid sorbent support that comprises pores; and
secondary amines that are covalently attached to the solid sorbent support and are confined inside the pores of the solid sorbent support; wherein
the solid sorbent is obtainable according to the method of any one of claims 9 to 18.

20. The solid sorbent according to any one of claims 1 to 8 and 19, wherein the solid sorbent has:
(a) a surface area of from around 20 to around 80 m²/g, and/or
(b) a pore volume of from around 0.15 to around 0.6 cm³/g, and/or
(c) a mean pore diameter of from around 26 to around 33 nm.

21. The solid sorbent according to any one of claims 1 to 8, 19 and 20, wherein the sorbent is for use in a fixed sorbent bed or in a moving sorbent bed.

22. The solid sorbent according to any one of claims 1 to 8, 19 and 20, wherein the sorbent is for use in a pellet form or in a powder form.

23. A method for the regeneration of a solid sorbent for use in a carbon dioxide capture process, wherein:
a solid sorbent containing carbon dioxide is heated at a temperature of from 120 to 150° C. to release the carbon dioxide contained in the solid sorbent; and
the solid sorbent is a solid sorbent according to any one of claims 1 to 8, 19 and 20.

24. Use of a solid sorbent in the adsorption of carbon dioxide, wherein:
the adsorption of carbon dioxide is performed at a temperature of less than 100° C.; and
the solid sorbent is a solid sorbent according to any one of claims 1 to 8, 19 and 20.

25. Use of a solid sorbent in a carbon dioxide capture process that employs temperature swing adsorption with carbon dioxide purge as a desorption strategy, wherein the solid sorbent is a solid sorbent according to any one of claims 1 to 8, 19 and 20.
